(19) United States
(12) Patent Application Publication
(10) Pub. No.: US 2020/0099927 A1
(43) Pub. Date: Mar. 26, 2020

(54) MOST PROBABLE MODES (MPMS) CONSTRUCTION

(71) Applicant: QUALCOMM Incorporated, San Diego, CA (US)

(72) Inventors: Adarsh Krishnan Ramasubramonian, Irvine, CA (US); Geert Van Der Auwera, Del Mar, CA (US); Cheng-Teh Hsieh, Del Mar, CA (US); Marta Karczewicz, San Diego, CA (US)

(21) Appl. No.: 16/578,107

(22) Filed: Sep. 20, 2019

Related U.S. Application Data
(60) Provisional application No. 62/735,812, filed on Sep. 24, 2018.
(60) Provisional application No. 62/741,145, filed on Oct. 4, 2018.
(60) Provisional application No. 62/779,194, filed on Dec. 13, 2018.

(51) Int. Cl. H04N 19/11; H04N 19/184; H04N 19/159; H04N 19/176; H04N 19/91; H04N 19/136

(52) U.S. Cl. CPC H04N 19/11; H04N 19/184; H04N 19/136; H04N 19/176; H04N 19/91; H04N 19/159

(57) ABSTRACT

A method, apparatus, and system for signaling non-MPM (most probable mode) in intra prediction is discussed. A set of non-MPMs is partially sorted and indexed in view of the MPMs. This reduces complexity of the encoding and signaling.

This application claims the benefit of U.S. Provisional Application No. 62/735,812, filed Sep. 24, 2018 (Atty. Dkt. No. 185266P1), U.S. Provisional Application No. 62/741,145, filed Oct. 4, 2018 (Atty. Dkt. No. 185266P2), and U.S. Provisional Application No. 62/779,194, filed Dec. 13, 2018 (Atty. Dkt. No. 185266P3), the entire content of which is incorporated by reference herein.

### TECHNICAL FIELD

This disclosure relates to video encoding and video decoding.

### BACKGROUND

Digital video capabilities can be incorporated into a wide range of devices, including digital televisions, digital direct broadcast systems, wireless broadcast systems, personal digital assistants (PDAs), laptop or desktop computers, tablet computers, e-book readers, digital cameras, digital recording devices, digital media players, video gaming devices, video game consoles, cellular or satellite radio telephones, so-called “smart phones,” video teleconferencing devices, video streaming devices, and the like. Digital video devices implement video coding techniques, such as those described in the standards defined by MPEG-2, MPEG-4, ITU-T H.263, ITU-T H.264/MPEG-4, Part 10, Advanced Video Coding (AVC), the High Efficiency Video Coding (HEVC) standard, ITU-T H.265/High Efficiency Video Coding (HEVC), and extensions of such standards. The video devices may transmit, receive, encode, decode, and/or store digital video information more efficiently by implementing such video coding techniques.

Video coding techniques include spatial (intra-picture) prediction and/or temporal (inter-picture) prediction to reduce or remove redundancy inherent in video sequences. For block-based video coding, a video slice (e.g., a video picture or a portion of a video picture) may be partitioned into video blocks, which may also be referred to as coding tree units (CTUs), coding units (CUs) and/or coding nodes. Video blocks in an intra-coded (I) slice of a picture are encoded using spatial prediction with respect to reference samples in neighboring blocks in the same picture. Video blocks in an inter-coded (P or B) slice of a picture may use spatial prediction with respect to reference samples in neighboring blocks in the same picture or temporal prediction with respect to reference samples in other reference pictures. Pictures may be referred to as frames, and reference pictures may be referred to as reference frames.

### SUMMARY

In general, this disclosure describes techniques for inter-prediction coding in video codecs. The details of one or more examples are set forth in the accompanying drawings and the description below. Other features, objects, and advantages will be apparent from the description, drawings, and claims.

In one example embodiment, a method for decoding video data is discussed. The method may include receiving a bitstream encoding video data to be stored or displayed, the video data include a plurality of blocks. The method may include determining a set of most probable modes (MPMs) for intra prediction of a current block to be decoded, wherein the set of MPMs includes intra prediction modes of previously coded neighboring blocks. The method may include determining a set of non-MPMs, wherein the set of non-MPMs include intra prediction modes not in the set of MPMs. The method may include parsing a MPM index or a non-MPM index indicating a selected intra prediction mode for the current block from the bitstream. The method may include decoding the current block of the video data using the selected inter prediction. A subset of the MPMs may be unique. The set of non-MPMs may be further indexed based on the subset of unique MPMs. The subset of unique MPMs may be sorted. The set of MPMs may further include one or more default intra prediction modes. The MPM index or non-MPM index may be entropy decoded with context from the bitstream. A quantity of MPMs in the set of MPMs may be dependent on at least one of: a current block size, a current block characteristic, and a current block neighborhood. The method may include parsing the quantity of MPMs from the bitstream.

In another example embodiment, a method for encoding video data is discussed. The method may include receiving a video data to be encoded, the video data include a plurality of blocks. The method may include determining a set of most probable modes (MPMs) for intra prediction of a current block to be encoded, wherein the set of MPMs includes intra prediction modes of previously coded neighboring blocks. The method may include determining a set of non-MPMs, wherein the set of non-MPMs include intra prediction modes not in the set of MPMs. The method may include encoding a current block using a selected intra prediction mode. The method may include encoding the video data and a MPM index or a non-MPM index indicating the selected intra prediction mode into a bitstream to be stored or displayed. A subset of the MPMs may be unique. The set of non-MPMs may be further indexed based on the subset of unique MPMs. The subset of unique MPMs may be sorted. The set of MPMs may further include one or more default intra prediction modes. The MPM index or non-MPM index may be entropy decoded with context from the bitstream. A quantity of MPMs in the set of MPMs may be dependent on at least one of: a current block size, a current block characteristic, and a current block neighborhood. The method may include signaling the quantity of MPMs in the set of MPMs from the bitstream.

In another example embodiment, an apparatus for decoding video data is discussed. The apparatus may include an input interface for receiving a bitstream encoding video data to be stored or displayed, the video data include a plurality of blocks. The apparatus may include a processor, the processor configured to, determine a set of most probable modes (MPMs) for intra prediction of a current block to be decoded, wherein the set of MPMs includes intra prediction modes of previously coded neighboring blocks, determine a set of non-MPMs, wherein the set of non-MPMs include intra prediction modes not in the set of MPMs, parse a MPM index or a non-MPM index indicating a selected intra prediction mode for the current block from the bitstream, and decode the current block of the video data using the selected inter prediction. A subset of the MPMs may be unique. The set of non-MPMs may be further indexed based on the subset of unique MPMs. The subset of unique MPMs may be sorted. The set of MPMs may further include one or more default intra prediction modes. The MPM index or non-MPM index may be entropy decoded with context from the bitstream. A quantity of MPMs in the set of MPMs may be dependent on at least one of: a current block size, a current block characteristic, and a current block neighborhood. The processor may be further configured to parse the quantity of MPMs from the bitstream.

In another example embodiment, an apparatus for encoding video data is discussed. The apparatus may include a receiver for receiving a video data from a video source to be encoded, the video data include a plurality of blocks. The apparatus may include a processor, the processor configured to, determine a set of most probable modes (MPMs) for intra prediction of a current block to be encoded, wherein the set of MPMs includes intra prediction modes of previously coded neighboring blocks, determine a set of non-MPMs, wherein the set of non-MPMs include intra prediction modes not in the set of MPMs, encode a current block using a selected intra prediction mode, and encode the video data and a MPM index or a non-MPM index indicating the selected intra prediction mode into a bitstream to be stored or displayed. A subset of the MPMs may be unique. The set of non-MPMs may be further indexed based on the subset of unique MPMs. The subset of unique MPMs may be sorted. The set of MPMs may further include one or more default intra prediction modes. The MPM index or non-MPM index may be entropy decoded with context from the bitstream. A quantity of MPMs in the set of MPMs may be dependent on at least one of: a current block size, a current block characteristic, and a current block neighborhood. The processor may be further configured to signal the quantity of MPMs in the set of MPMs from the bitstream.

### BRIEF DESCRIPTION OF DRAWINGS

FIG. 1 illustrates a block diagram illustrating an example video encoding and decoding system that may perform the techniques of this disclosure.

FIG. 2 illustrates a block diagram illustrating an example video encoder that may perform the techniques of this disclosure.

FIG. 3 illustrates a block diagram illustrating an example video decoder that may perform the techniques of this disclosure.

FIG. 4 illustrates a flowchart illustrating an example encoding method.

### DETAILED DESCRIPTION

In video coding, using intra prediction modes of already coded neighbor blocks as a predictor of most probable modes (MPM) may have performance benefits. Unfortunately, this leaves many remaining non-MPM modes to be coded with more bits. An improved MPM mode signaling system is discussed herein. A prior MPM sorting algorithm may be replaced with a partial sorting algorithm by identifying one mode (neither planar (PL) nor DC prediction (DC)) to enable re-indexing of the modes without full sorting. Instead, within existing MPM derivation, one mode M that is neither PL nor DC is identified. Mode M is integrated in the derivation of the MPM, and hence no additional conditional checks are needed. The modes PL, DC and M are used to re-index the non-MPM modes with a simple comparison and addition. This reduces complexity of the encoding and signaling.

Video coding standards include ITU-T H.261, ISO/IEC MPEG-1 Visual, ITU-T H.262 or ISO/IEC MPEG-2 Visual, ITU-T H.263, ISO/IEC MPEG-4 Visual and ITU-T H.264 (also known as ISO/IEC MPEG-4 AVC), including its Scalable Video Coding (SVC) and Multi-view Video Coding (MVC) extensions.

In addition, a new video coding standard, namely High Efficiency Video Coding (HEVC) or ITU-T H.265, including its range extension, multiview extension (MV-HEVC) and scalable extension (SHVC), has recently been developed by the Joint Collaboration Team on Video Coding (JCT-VC) as well as Joint Collaboration Team on 3D Video Coding Extension Development (JCT-3V) of ITU-T Video Coding Experts Group (VCEG) and ISO/IEC Motion Picture Experts Group (MPEG). This also includes extensions such as Screen content coding (SCC).

The latest HEVC draft specification, and referred to as HEVC WD hereinafter, is available from http://phenix.int-evry.fr/jct/doc_end_user/documents/14_Vienna/wg11/JCTVC-N1003-v1.zip

ITU-T VCEG (Q6/16) and ISO/IEC MPEG (JTC 1/SC 29/WG 11) studied the potential need for standardization of future video coding technology with a compression capability that significantly exceeds that of the current HEVC standard (including its current extensions and near-term extensions for screen content coding and high-dynamic-range coding). The groups are working together on this exploration activity in a joint collaboration effort known as the Joint Video Exploration Team (JVET) to evaluate compression technology designs proposed by their experts in this area. The JVET first met during 19-21 Oct. 2015. And the latest version of reference software, i.e., Joint Exploration Model 7 (JEM 7) could be downloaded from:

https://jvet.hhi.fraunhofer.de/svn/svn_HMJEMSoftware/tags/HM-16.6-JEM-73.0/

An algorithm description of Joint Exploration Test Model 7 (JEM7) could be referred to JVET-G1001.

The Joint Video Experts Team (JVET) of ITU-T WP3/16 and ISO/IEC JTC 1/SC 29/WG 11 held its eleventh meeting during 10-18 Jul. 2018 at the GR-Ljubljana Exhibition and Convention Centre (Dunajska cesta 18, 1000 Ljubljana, Slovenia). The name Versatile Video Coding (VVC) was chosen as the informal nickname for the new standard. The reference software VTM and BMS could be download from:

https://jvet.hhi.fraunhofer.de/svn/svn_VVCSoftware_VTM/
https://jvet.hhi.fraunhofer.de/svn/svn_VVCSoftware_BMS/

Video coding standards also includes the Versatile Video Coding (VVC) standard discussed above, currently under development by the JVET group. A recent version of the draft, Draft 2, of the specification may be obtained from http://phenix.it-sudparis.eu/jvet/doc_end_user/documents/11_Ljubljana/wg11/JVET-K1001-v6.zip, henceforth referred as JVET Draft 2.

An Algorithm description could be referred to JVET-K1002.

Video coding standards also include proprietary video codecs, such Google's VP8, VP9, VP10, etc. and video codecs developed by other organizations, for example, the Alliance for Open Media.

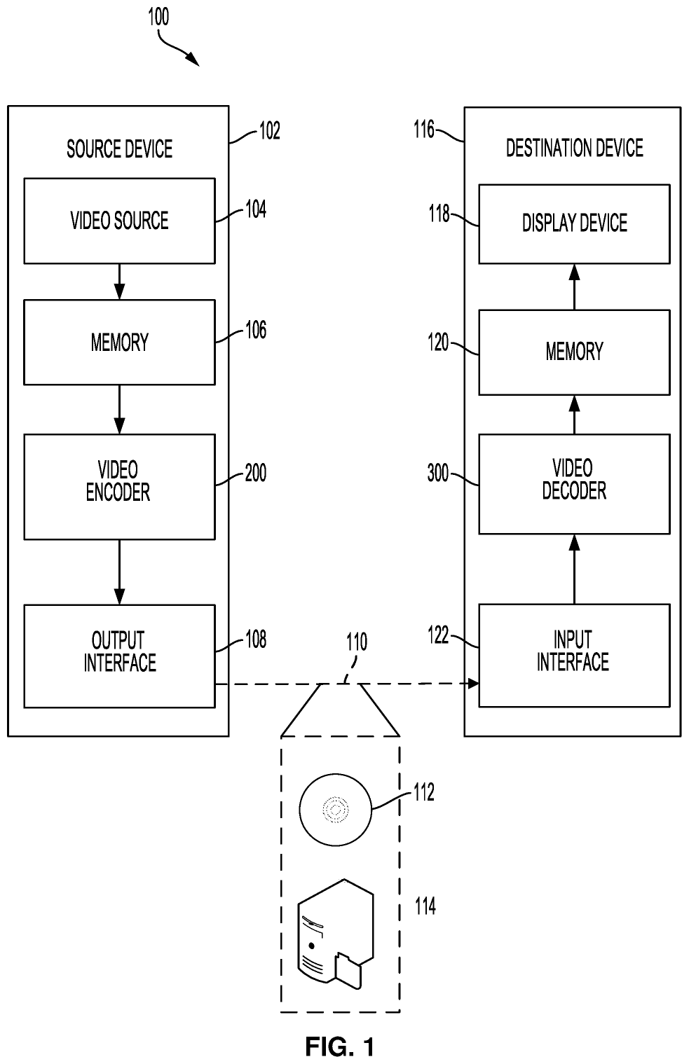

FIG. 1 illustrates a block diagram illustrating an example video encoding and decoding system 100 that may perform the techniques of this disclosure. The techniques of this disclosure are generally directed to coding (encoding and/or decoding) video data. In general, video data includes any data for processing a video. Thus, video data may include raw, uncoded video, encoded video, decoded (e.g., reconstructed) video, and video metadata, such as signaling data.

As shown in FIG. 1, system 100 includes a source device 102 that provides encoded video data to be decoded and displayed by a destination device 116, in this example. In particular, source device 102 provides the video data to destination device 116 via a computer-readable medium 110. Source device 102 and destination device 116 may comprise any of a wide range of devices, including desktop computers, notebook (i.e., laptop) computers, tablet computers, set-top boxes, telephone handsets such smartphones, televisions, cameras, display devices, digital media players, video gaming consoles, video streaming device, or the like. In some cases, source device 102 and destination device 116 may be equipped for wireless communication, and thus may be referred to as wireless communication devices.

In the example of FIG. 1, source device 102 includes video source 104, memory 106, video encoder 200, and output interface 108. Destination device 116 includes input interface 122, video decoder 300, memory 120, and display device 118. In accordance with this disclosure, video encoder 200 of source device 102 and video decoder 300 of destination device 116 may be configured to apply the techniques for pruning non-adjacent merge candidates. Thus, source device 102 represents an example of a video encoding device, while destination device 116 represents an example of a video decoding device. In other examples, a source device and a destination device may include other components or arrangements. For example, source device 102 may receive video data from an external video source, such as an external camera. Likewise, destination device 116 may interface with an external display device, rather than including an integrated display device.

System 100 as shown in FIG. 1 is merely one example. In general, any digital video encoding and/or decoding device may perform techniques for pruning non-adjacent merge candidates. Source device 102 and destination device 116 are merely examples of such coding devices in which source device 102 generates coded video data for transmission to destination device 116. This disclosure refers to a “coding” device as a device that performs coding (encoding and/or decoding) of data. Thus, video encoder 200 and video decoder 300 represent examples of coding devices, in particular, a video encoder and a video decoder, respectively. In some examples, devices 102, 116 may operate in a substantially symmetrical manner such that each of devices 102, 116 include video encoding and decoding components. Hence, system 100 may support one-way or two-way video transmission between video devices 102, 116, e.g., for video streaming, video playback, video broadcasting, or video telephony.

In general, video source 104 represents a source of video data (i.e., raw, uncoded video data) and provides a sequential series of pictures (also referred to as “frames”) of the video data to video encoder 200, which encodes data for the pictures. Video source 104 of source device 102 may include a video capture device, such as a video camera, a video archive containing previously captured raw video, and/or a video feed interface to receive video from a video content provider. As a further alternative, video source 104 may generate computer graphics-based data as the source video, or a combination of live video, archived video, and computer-generated video. In each case, video encoder 200 encodes the captured, pre-captured, or computer-generated video data. Video encoder 200 may rearrange the pictures from the received order (sometimes referred to as “display order”) into a coding order for coding. Video encoder 200 may generate a bitstream including encoded video data. Source device 102 may then output the encoded video data via output interface 108 onto computer-readable medium 110 for reception and/or retrieval by, e.g., input interface 122 of destination device 116.

Memory 106 of source device 102 and memory 120 of destination device 116 represent general purpose memories. In some example, memories 106, 120 may store raw video data, e.g., raw video from video source 104 and raw, decoded video data from video decoder 300. Additionally or alternatively, memories 106, 120 may store software instructions executable by, e.g., video encoder 200 and video decoder 300, respectively. Although shown separately from video encoder 200 and video decoder 300 in this example, it should be understood that video encoder 200 and video decoder 300 may also include internal memories for functionally similar or equivalent purposes. Furthermore, memories 106, 120 may store encoded video data, e.g., output from video encoder 200 and input to video decoder 300. In some examples, portions of memories 106, 120 may be allocated as one or more video buffers, e.g., to store raw, decoded, and/or encoded video data.

Computer-readable medium 110 may represent any type of medium or device capable of transporting the encoded video data from source device 102 to destination device 116. In one example, computer-readable medium 110 represents a communication medium to enable source device 102 to transmit encoded video data directly to destination device 116 in real-time, e.g., via a radio frequency network or computer-based network. Output interface 108 may modulate a transmission signal including the encoded video data, and input interface 122 may modulate the received transmission signal, according to a communication standard, such as a wireless communication protocol. The communication medium may comprise any wireless or wired communication medium, such as a radio frequency (RF) spectrum or one or more physical transmission lines. The communication medium may form part of a packet-based network, such as a local area network, a wide-area network, or a global network such as the Internet. The communication medium may include routers, switches, base stations, or any other equipment that may be useful to facilitate communication from source device 102 to destination device 116.

In some examples, source device 102 may output encoded data from output interface 108 to storage device 116. Similarly, destination device 116 may access encoded data from storage device 116 via input interface 122. Storage device 116 may include any of a variety of distributed or locally accessed data storage media such as a hard drive, Blu-ray discs, DVDs, CD-ROMs, flash memory, volatile or non-volatile memory, or any other suitable digital storage media for storing encoded video data.

In some examples, source device 102 may output encoded video data to file server 114 or another intermediate storage device that may store the encoded video generated by source device 102. Destination device 116 may access stored video data from file server 114 via streaming or download. File server 114 may be any type of server device capable of storing encoded video data and transmitting that encoded video data to the destination device 116. File server 114 may represent a web server (e.g., for a website), a File Transfer Protocol (FTP) server, a content delivery network device, or a network attached storage (NAS) device. Destination device 116 may access encoded video data from file server 114 through any standard data connection, including an Internet connection. This may include a wireless channel (e.g., a Wi-Fi connection), a wired connection (e.g., DSL, cable modem, etc.), or a combination of both that is suitable for accessing encoded video data stored on file server 114. File server 114 and input interface 122 may be configured to operate according to a streaming transmission protocol, a download transmission protocol, or a combination thereof.

Output interface 108 and input interface 122 may represent wireless transmitters/receiver, modems, wired networking components (e.g., Ethernet cards), wireless communication components that operate according to any of a variety of IEEE 802.11 standards, or other physical components. In examples where output interface 108 and input interface 122 comprise wireless components, output interface 108 and input interface 122 may be configured to transfer data, such as encoded video data, according to a cellular communication standard, such as 4G, 4G-LTE (Long-Term Evolution), LTE Advanced, 5G, or the like. In some examples where output interface 108 comprises a wireless transmitter, output interface 108 and input interface 122 may be configured to transfer data, such as encoded video data, according to other wireless standards, such as an IEEE 802.11 specification, an IEEE 802.15 specification (e.g., ZigBee™), a Bluetooth™ standard, or the like. In some examples, source device 102 and/or destination device 116 may include respective system-on-a-chip (SoC) devices. For example, source device 102 may include an SoC device to perform the functionality attributed to video encoder 200 and/or output interface 108, and destination device 116 may include an SoC device to perform the functionality attributed to video decoder 300 and/or input interface 122.

The techniques of this disclosure may be applied to video coding in support of any of a variety of multimedia applications, such as over-the-air television broadcasts, cable television transmissions, satellite television transmissions, Internet streaming video transmissions, such as dynamic adaptive streaming over HTTP (DASH), digital video that is encoded onto a data storage medium, decoding of digital video stored on a data storage medium, or other applications.

Input interface 122 of destination device 116 receives an encoded video bitstream from computer-readable medium 110 (e.g., storage device 112, file server 114, or the like). The encoded video bitstream computer-readable medium 110 may include signaling information defined by video encoder 200, which is also used by video decoder 300, such as syntax elements having values that describe characteristics and/or processing of video blocks or other coded units (e.g., slices, pictures, groups of pictures, sequences, or the like). Display device 118 displays decoded pictures of the decoded video data to a user. Display device 118 may represent any of a variety of display devices such as a cathode ray tube (CRT), a liquid crystal display (LCD), a plasma display, an organic light emitting diode (OLED) display, or another type of display device.

Although not shown in FIG. 1, in some examples, video encoder 200 and video decoder 300 may each be integrated with an audio encoder and/or audio decoder, and may include appropriate MUX-DEMUX units, or other hardware and/or software, to handle multiplexed streams including both audio and video in a common data stream. If applicable, MUX-DEMUX units may conform to the ITU H.223 multiplexer protocol, or other protocols such as the user datagram protocol (UDP).

Video encoder 200 and video decoder 300 each may be implemented as any of a variety of suitable encoder and/or decoder circuitry, such as one or more microprocessors, digital signal processors (DSPs), application specific integrated circuits (ASICs), field programmable gate arrays (FPGAs), discrete logic, software, hardware, firmware or any combinations thereof. When the techniques are implemented partially in software, a device may store instructions for the software in a suitable, non-transitory computer-readable medium and execute the instructions in hardware using one or more processors to perform the techniques of this disclosure. Each of video encoder 200 and video decoder 300 may be included in one or more encoders or decoders, either of which may be integrated as part of a combined encoder/decoder (CODEC) in a respective device. A device including video encoder 200 and/or video decoder 300 may comprise an integrated circuit, a microprocessor, and/or a wireless communication device, such as a cellular telephone.

Video encoder 200 and video decoder 300 may operate according to a video coding standard, such as ITU-T H.265, also referred to as High Efficiency Video Coding (HEVC) or extensions thereto, such as the multi-view and/or scalable video coding extensions. Alternatively, video encoder 200 and video decoder 300 may operate according to other proprietary or industry standards, such as the Joint Exploration Test Model (JEM). The techniques of this disclosure, however, are not limited to any particular coding standard.

In general, video encoder 200 and video decoder 300 may perform block-based coding of pictures. The term “block” generally refers to a structure including data to be processed (e.g., encoded, decoded, or otherwise used in the encoding and/or decoding process). For example, a block may include a two-dimensional matrix of samples of luminance and/or chrominance data. In general, video encoder 200 and video decoder 300 may code video data represented in a YUV (e.g., Y, Cb, Cr) format. That is, rather than coding red, green, and blue (RGB) data for samples of a picture, video encoder 200 and video decoder 300 may code luminance and chrominance components, where the chrominance components may include both red hue and blue hue chrominance components. In some examples, video encoder 200 converts received RGB formatted data to a YUV representation prior to encoding, and video decoder 300 converts the YUV representation to the RGB format. Alternatively, pre- and post-processing units (not shown) may perform these conversions.

This disclosure may generally refer to coding (e.g., encoding and decoding) of pictures to include the process of encoding or decoding data of the picture. Similarly, this disclosure may refer to coding of blocks of a picture to include the process of encoding or decoding data for the blocks, e.g., prediction and/or residual coding. An encoded video bitstream generally includes a series of values for syntax elements representative of coding decisions (e.g., coding modes) and partitioning of pictures into blocks. Thus, references to coding a picture or a block should generally be understood as coding values for syntax elements forming the picture or block.

HEVC defines various blocks, including coding units (CUs), prediction units (PUs), and transform units (TUs). According to HEVC, a video coder (such as video encoder 200) partitions a coding tree unit (CTU) into CUs according to a quadtree structure. That is, the video coder partitions CTUs and CUs into four equal, non-overlapping squares, and each node of the quadtree has either zero or four child nodes. Nodes without child nodes may be referred to as “leaf nodes,” and CUs of such leaf nodes may include one or more PUs and/or one or more TUs. The video coder may further partition PUs and TUs. For example, in HEVC, a residual quadtree (RQT) represents partitioning of TUs. In HEVC, PUs represent inter-prediction data, while TUs represent residual data. CUs that are intra-predicted include intra-prediction information, such as an intra-mode indication.

As another example, video encoder 200 and video decoder 300 may be configured to operate according to JEM. According to JEM, a video coder (such as video encoder 200) partitions a picture into a plurality of coding tree units (CTUs). Video encoder 200 may partition a CTU according to a tree structure, such as a quadtree-binary tree (QTBT) structure. The QTBT structure of JEM removes the concepts of multiple partition types, such as the separation between CUs, PUs, and TUs of HEVC. A QTBT structure of JEM includes two levels: a first level partitioned according to quadtree partitioning, and a second level partitioned according to binary tree partitioning. A root node of the QTBT structure corresponds to a CTU. Leaf nodes of the binary trees correspond to coding units (CUs).

In some examples, video encoder 200 and video decoder 300 may use a single QTBT structure to represent each of the luminance and chrominance components, while in other examples, video encoder 200 and video decoder 300 may use two or more QTBT structures, such as one QTBT structure for the luminance component and another QTBT structure for both chrominance components (or two QTBT structures for respective chrominance components).

Video encoder 200 and video decoder 300 may be configured to use quadtree partitioning per HEVC, QTBT partitioning according to JEM, or other partitioning structures. For purposes of explanation, the description of the techniques of this disclosure is presented with respect to QTBT partitioning. However, it should be understood that the techniques of this disclosure may also be applied to video coders configured to use quadtree partitioning, or other types of partitioning as well.

This disclosure may use “N×N” and “N by N” interchangeably to refer to the sample dimensions of a block (such as a CU or other video block) in terms of vertical and horizontal dimensions, e.g., 16×16 samples or 16 by 16 samples. In general, a 16×16 CU will have 16 samples in a vertical direction (y=16) and 16 samples in a horizontal direction (x=16). Likewise, an N×N CU generally has N samples in a vertical direction and N samples in a horizontal direction, where N represents a nonnegative integer value. The samples in a CU may be arranged in rows and columns. Moreover, CUs need not necessarily have the same number of samples in the horizontal direction as in the vertical direction. For example, CUs may comprise N×M samples, where M is not necessarily equal to N.

Video encoder 200 encodes video data for CUs representing prediction and/or residual information, and other information. The prediction information indicates how the CU is to be predicted in order to form a prediction block for the CU. The residual information generally represents sample-by-sample differences between samples of the CU prior to encoding and the prediction block.

To predict a CU, video encoder 200 may generally form a prediction block for the CU through inter-prediction or intra-prediction. Inter-prediction generally refers to predicting the CU from data of a previously coded picture, whereas intra-prediction generally refers to predicting the CU from previously coded data of the same picture. To perform inter-prediction, video encoder 200 may generate the prediction block using one or more motion vectors. Video encoder 200 may generally perform a motion search to identify a reference block that closely matches the CU, e.g., in terms of differences between the CU and the reference block. Video encoder 200 may calculate a difference metric using a sum of absolute difference (SAD), sum of squared differences (SSD), mean absolute difference (MAD), mean squared differences (MSD), or other such difference calculations to determine whether a reference block closely matches the current CU. In some examples, video encoder 200 may predict the current CU using uni-directional prediction or bi-directional prediction.

JEM also provides an affine motion compensation mode, which may be considered an inter-prediction mode. In affine motion compensation mode, video encoder 200 may determine two or more motion vectors that represent non-translational motion, such as zoom in or out, rotation, perspective motion, or other irregular motion types.

To perform intra-prediction, video encoder 200 may select an intra-prediction mode to generate the prediction block. JEM provides sixty-seven intra-prediction modes, including various directional modes, as well as planar mode and DC mode. In general, video encoder 200 selects an intra-prediction mode that describes neighboring samples to a current block (e.g., a block of a CU) from which to predict samples of the current block. Such samples may generally be above, above and to the left, or to the left of the current block in the same picture as the current block, assuming video encoder 200 codes CTUs and CUs in raster scan order (left to right, top to bottom).

Video encoder 200 encodes data representing the prediction mode for a current block. For example, for inter-prediction modes, video encoder 200 may encode data representing which of the various available inter-prediction modes is used, as well as motion information for the corresponding mode. For uni-directional or bi-directional inter-prediction, for example, video encoder 200 may encode motion vectors using advanced motion vector prediction (AMVP) or merge mode. Video encoder 200 may use similar modes to encode motion vectors for affine motion compensation mode.

Following prediction, such as intra-prediction or inter-prediction of a block, video encoder 200 may calculate residual data for the block. The residual data, such as a residual block, represents sample by sample differences between the block and a prediction block for the block, formed using the corresponding prediction mode. Video encoder 200 may apply one or more transforms to the residual block, to produce transformed data in a transform domain instead of the sample domain. For example, video encoder 200 may apply a discrete cosine transform (DCT), an integer transform, a wavelet transform, or a conceptually similar transform to residual video data. Additionally, video encoder 200 may apply a secondary transform following the first transform, such as a mode-dependent non-separable secondary transform (MDNSST), a signal dependent transform, a Karhunen-Loeve transform (KLT), or the like. Video encoder 200 produces transform coefficients following application of the one or more transforms.

As noted above, following any transforms to produce transform coefficients, video encoder 200 may perform quantization of the transform coefficients. Quantization generally refers to a process in which transform coefficients are quantized to possibly reduce the amount of data used to represent the coefficients, providing further compression. By performing the quantization process, video encoder 200 may reduce the bit depth associated with some or all of the coefficients. For example, video encoder 200 may round an n-bit value down to an m-bit value during quantization, where n is greater than m. In some examples, to perform quantization, video encoder 200 may perform a bitwise right-shift of the value to be quantized.

Following quantization, video encoder 200 may scan the transform coefficients, producing a one-dimensional vector from the two-dimensional matrix including the quantized transform coefficients. The scan may be designed to place higher energy (and therefore lower frequency) coefficients at the front of the vector and to place lower energy (and therefore higher frequency) transform coefficients at the back of the vector. In some examples, video encoder 200 may utilize a predefined scan order to scan the quantized transform coefficients to produce a serialized vector, and then entropy encode the quantized transform coefficients of the vector. In other examples, video encoder 200 may perform an adaptive scan. After scanning the quantized transform coefficients to form the one-dimensional vector, video encoder 200 may entropy encode the one-dimensional vector, e.g., according to context-adaptive binary arithmetic coding (CABAC). Video encoder 200 may also entropy encode values for syntax elements describing metadata associated with the encoded video data for use by video decoder 300 in decoding the video data.

To perform CABAC, video encoder 200 may assign a context within a context model to a symbol to be transmitted. The context may relate to, for example, whether neighboring values of the symbol are zero-valued or not. The probability determination may be based on a context assigned to the symbol.

Video encoder 200 may further generate syntax data, such as block-based syntax data, picture-based syntax data, and sequence-based syntax data, to video decoder 300, e.g., in a picture header, a block header, a slice header, or other syntax data, such as a sequence parameter set (SPS), picture parameter set (PPS), or video parameter set (VPS). Video decoder 300 may likewise decode such syntax data to determine how to decode corresponding video data.

In this manner, video encoder 200 may generate a bitstream including encoded video data, e.g., syntax elements describing partitioning of a picture into blocks (e.g., CUs) and prediction and/or residual information for the blocks. Ultimately, video decoder 300 may receive the bitstream and decode the encoded video data.

In general, video decoder 300 performs a reciprocal process to that performed by video encoder 200 to decode the encoded video data of the bitstream. For example, video decoder 300 may decode values for syntax elements of the bitstream using CABAC in a manner substantially similar to, albeit reciprocal to, the CABAC encoding process of video encoder 200. The syntax elements may define partitioning information of a picture into CTUs, and partitioning of each CTU according to a corresponding partition structure, such as a QTBT structure, to define CUs of the CTU. The syntax elements may further define prediction and residual information for blocks (e.g., CUs) of video data.

The residual information may be represented by, for example, quantized transform coefficients. Video decoder 300 may inverse quantize and inverse transform the quantized transform coefficients of a block to reproduce a residual block for the block. Video decoder 300 uses a signaled prediction mode (intra- or inter-prediction) and related prediction information (e.g., motion information for inter-prediction) to form a prediction block for the block. Video decoder 300 may then combine the prediction block and the residual block (on a sample-by-sample basis) to reproduce the original block. Video decoder 300 may perform additional processing, such as performing a deblocking process to reduce visual artifacts along boundaries of the block.

This disclosure may generally refer to “signaling” certain information, such as syntax elements. The term “signaling” may generally refer to the communication of values syntax elements and/or other data used to decode encoded video data. That is, video encoder 200 may signal values for syntax elements in the bitstream. In general, signaling refers to generating a value in the bitstream. As noted above, source device 102 may transport the bitstream to destination device 116 substantially in real time, or not in real time, such as might occur when storing syntax elements to storage device 112 for later retrieval by destination device 116.

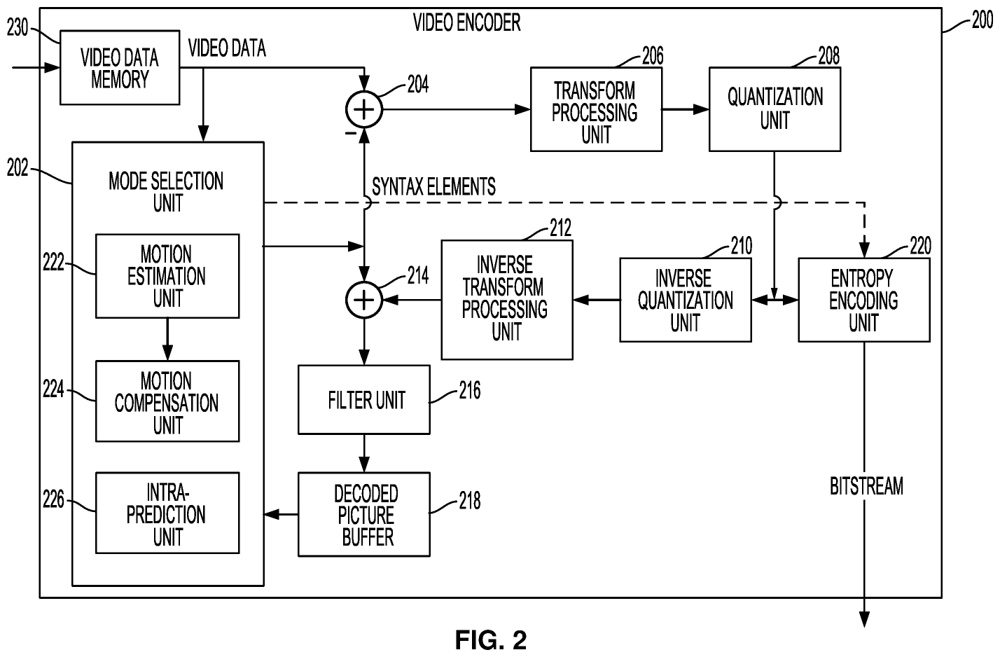

In the example of FIG. 2, video encoder 200 includes video data memory 230, mode selection unit 202, residual generation unit 204, transform processing unit 206, quantization unit 208, inverse quantization unit 210, inverse transform processing unit 212, reconstruction unit 214, filter unit 216, decoded picture buffer (DPB) 218, and entropy encoding unit 220.

Video data memory 230 may store video data to be encoded by the components of video encoder 200. Video encoder 200 may receive the video data stored in video data memory 230 from, for example, video source 104 (FIG. 1). DPB 218 may act as a reference picture memory that stores reference video data for use in prediction of subsequent video data by video encoder 200. Video data memory 230 and DPB 218 may be formed by any of a variety of memory devices, such as dynamic random access memory (DRAM), including synchronous DRAM (SDRAM), magnetoresistive RAM (MRAM), resistive RAM (RRAM), or other types of memory devices. Video data memory 230 and DPB 218 may be provided by the same memory device or separate memory devices. In various examples, video data memory 230 may be on-chip with other components of video encoder 200, as illustrated, or off-chip relative to those components.

In this disclosure, reference to video data memory 230 should not be interpreted as being limited to memory internal to video encoder 200, unless specifically described as such, or memory external to video encoder 200, unless specifically described as such. Rather, reference to video data memory 230 should be understood as reference memory that stores video data that video encoder 200 receives for encoding (e.g., video data for a current block that is to be encoded). Memory 106 of FIG. 1 may also provide temporary storage of outputs from the various units of video encoder 200.

The various units of FIG. 2 are illustrated to assist with understanding the operations performed by video encoder 200. The units may be implemented as fixed-function circuits, programmable circuits, or a combination thereof. Fixed-function circuits refer to circuits that provide particular functionality, and are preset on the operations that can be performed. Programmable circuits refer to circuits that can programmed to perform various tasks, and provide flexible functionality in the operations that can be performed. For instance, programmable circuits may execute software or firmware that cause the programmable circuits to operate in the manner defined by instructions of the software or firmware. Fixed-function circuits may execute software instructions (e.g., to receive parameters or output parameters), but the types of operations that the fixed-function circuits perform are generally immutable. In some examples, the one or more of the units may be distinct circuit blocks (fixed-function or programmable), and in some examples, the one or more units may be integrated circuits.

Video encoder 200 may include arithmetic logic units (ALUs), elementary function units (EFUs), digital circuits, analog circuits, and/or programmable cores, formed from programmable circuits. In examples where the operations of video encoder 200 are performed using software executed by the programmable circuits, memory 106 (FIG. 1) may store the object code of the software that video encoder 200 receives and executes, or another memory within video encoder 200 (not shown) may store such instructions.

Video data memory 230 is configured to store received video data. Video encoder 200 may retrieve a picture of the video data from video data memory 230 and provide the video data to residual generation unit 204 and mode selection unit 202. Video data in video data memory 230 may be raw video data that is to be encoded.

Mode selection unit 202 includes a motion estimation unit 222, motion compensation unit 224, and an intra-prediction unit 226. Mode selection unit 202 may include additional functional units to perform video prediction in accordance with other prediction modes. As examples, mode selection unit 202 may include a palette unit, an intra-block copy unit (which may be part of motion estimation unit 222 and/or motion compensation unit 224), an affine unit, a linear model (LM) unit, or the like.

Mode selection unit 202 generally coordinates multiple encoding passes to test combinations of encoding parameters and resulting rate-distortion values for such combinations. The encoding parameters may include partitioning of CTUs into CUs, prediction modes for the CUs, transform types for residual data of the CUs, quantization parameters for residual data of the CUs, and so on. Mode selection unit 202 may ultimately select the combination of encoding parameters having rate-distortion values that are better than the other tested combinations.

Video encoder 200 may partition a picture retrieved from video data memory 230 into a series of CTUs, and encapsulate one or more CTUs within a slice. Mode selection unit 202 may partition a CTU of the picture in accordance with a tree structure, such as the QTBT structure or the quad-tree structure of HEVC described above. As described above, video encoder 200 may form one or more CUs from partitioning a CTU according to the tree structure. Such a CU may also be referred to generally as a “video block” or “block.”

In general, mode selection unit 202 also controls the components thereof (e.g., motion estimation unit 222, motion compensation unit 224, and intra-prediction unit 226) to generate a prediction block for a current block (e.g., a current CU, or in HEVC, the overlapping portion of a PU and a TU). For inter-prediction of a current block, motion estimation unit 222 may perform a motion search to identify one or more closely matching reference blocks in one or more reference pictures (e.g., one or more previously coded pictures stored in DPB 218). In particular, motion estimation unit 222 may calculate a value representative of how similar a potential reference block is to the current block, e.g., according to sum of absolute difference (SAD), sum of squared differences (SSD), mean absolute difference (MAD), mean squared differences (MSD), or the like. Motion estimation unit 222 may generally perform these calculations using sample-by-sample differences between the current block and the reference block being considered. Motion estimation unit 222 may identify a reference block having a lowest value resulting from these calculations, indicating a reference block that most closely matches the current block.

Motion estimation unit 222 may form one or more motion vectors (MVs) that defines the positions of the reference blocks in the reference pictures relative to the position of the current block in a current picture. Motion estimation unit 222 may then provide the motion vectors to motion compensation unit 224. For example, for uni-directional inter-prediction, motion estimation unit 222 may provide a single motion vector, whereas for bi-directional inter-prediction, motion estimation unit 222 may provide two motion vectors. Motion compensation unit 224 may then generate a prediction block using the motion vectors. For example, motion compensation unit 224 may retrieve data of the reference block using the motion vector. As another example, if the motion vector has fractional sample precision, motion compensation unit 224 may interpolate values for the prediction block according to one or more interpolation filters. Moreover, for bi-directional inter-prediction, motion compensation unit 224 may retrieve data for two reference blocks identified by respective motion vectors and combine the retrieved data, e.g., through sample-by-sample averaging or weighted averaging.

As another example, for intra-prediction, or intra-prediction coding, intra-prediction unit 226 may generate the prediction block from samples neighboring the current block. For example, for directional modes, intra-prediction unit 226 may generally mathematically combine values of neighboring samples and populate these calculated values in the defined direction across the current block to produce the prediction block. As another example, for DC mode, intra-prediction unit 226 may calculate an average of the neighboring samples to the current block and generate the prediction block to include this resulting average for each sample of the prediction block.

Mode selection unit 202 provides the prediction block to residual generation unit 204. Residual generation unit 204 receives a raw, uncoded version of the current block from video data memory 230 and the prediction block from mode selection unit 202. Residual generation unit 204 calculates sample-by-sample differences between the current block and the prediction block. The resulting sample-by-sample differences define a residual block for the current block. In some examples, residual generation unit 204 may also determine differences between sample values in the residual block to generate a residual block using residual differential pulse code modulation (RDPCM). In some examples, residual generation unit 204 may be formed using one or more subtractor circuits that perform binary subtraction.

In examples where mode selection unit 202 partitions CUs into PUs, each PU may be associated with a luma prediction unit and corresponding chroma prediction units. Video encoder 200 and video decoder 300 may support PUs having various sizes. As indicated above, the size of a CU may refer to the size of the luma coding block of the CU and the size of a PU may refer to the size of a luma prediction unit of the PU. Assuming that the size of a particular CU is 2N×2N, video encoder 200 may support PU sizes of 2N×2N or N×N for intra prediction, and symmetric PU sizes of 2N×2N, 2N×N, N×2N, N×N, or similar for inter prediction. Video encoder 20 and video decoder 30 may also support asymmetric partitioning for PU sizes of 2N×nU, 2N×nD, nL×2N, and nR×2N for inter prediction.

In examples where mode selection unit does not further partition a CU into PUs, each CU may be associated with a luma coding block and corresponding chroma coding blocks. As above, the size of a CU may refer to the size of the luma coding block of the CU. The video encoder 200 and video decoder 120 may support CU sizes of 2N×2N, 2N×N, or N×2N.

For other video coding techniques such as an intra-block copy mode coding, an affine-mode coding, and linear model (LM) mode coding, as few examples, mode selection unit 202, via respective units associated with the coding techniques, generates a prediction block for the current block being encoded. In some examples, such as palette mode coding, mode selection unit 202 may not generate a prediction block, and instead generate syntax elements that indicate the manner in which to reconstruct the block based on a selected palette. In such modes, mode selection unit 202 may provide these syntax elements to entropy encoding unit 220 to be encoded.

As described above, residual generation unit 204 receives the video data for the current block and the corresponding prediction block. Residual generation unit 204 then generates a residual block for the current block. To generate the residual block, residual generation unit 204 calculates sample-by-sample differences between the prediction block and the current block. Thus,

Transform processing unit 206 applies one or more transforms to the residual block to generate a block of transform coefficients (referred to herein as a “transform coefficient block”). Transform processing unit 206 may apply various transforms to a residual block to form the transform coefficient block. For example, transform processing unit 206 may apply a discrete cosine transform (DCT), a directional transform, a Karhunen-Loeve transform (KLT), or a conceptually similar transform to a residual block. In some examples, transform processing unit 206 may perform multiple transforms to a residual block, e.g., a primary transform and a secondary transform, such as a rotational transform. In some examples, transform processing unit 206 does not apply transforms to a residual block.

Quantization unit 208 may quantize the transform coefficients in a transform coefficient block, to produce a quantized transform coefficient block. Quantization unit 208 may quantize transform coefficients of a transform coefficient block according to a quantization parameter (QP) value associated with the current block. Video encoder 200 (e.g., via mode selection unit 202) may adjust the degree of quantization applied to the coefficient blocks associated with the current block by adjusting the QP value associated with the CU. Quantization may introduce loss of information, and thus, quantized transform coefficients may have lower precision than the original transform coefficients produced by transform processing unit 206.

Inverse quantization unit 210 and inverse transform processing unit 212 may apply inverse quantization and inverse transforms to a quantized transform coefficient block, respectively, to reconstruct a residual block from the transform coefficient block. Reconstruction unit 214 may produce a reconstructed block corresponding to the current block (albeit potentially with some degree of distortion) based on the reconstructed residual block and a prediction block generated by mode selection unit 202. For example, reconstruction unit 214 may add samples of the reconstructed residual block to corresponding samples from the prediction block generated by mode selection unit 202 to produce the reconstructed block.

Filter unit 216 may perform one or more filter operations on reconstructed blocks. For example, filter unit 216 may perform deblocking operations to reduce blockiness artifacts along edges of CUs. Operations of filter unit 216 may be skipped, in some examples.

Video encoder 200 stores reconstructed blocks in DPB 218. For instance, in examples where operations of filter unit 216 are not needed, reconstruction unit 214 may store reconstructed blocks to DPB 218. In examples where operations of filter unit 216 are needed, filter unit 216 may store the filtered reconstructed blocks to DPB 218. Motion estimation unit 222 and motion compensation unit 224 may retrieve a reference picture from DPB 218, formed from the reconstructed (and potentially filtered) blocks, to inter-predict blocks of subsequently encoded pictures. In addition, intra-prediction unit 226 may use reconstructed blocks in DPB 218 of a current picture to intra-predict other blocks in the current picture.

In general, entropy encoding unit 220 may entropy encode syntax elements received from other functional components of video encoder 200. For example, entropy encoding unit 220 may entropy encode quantized transform coefficient blocks from quantization unit 208. As another example, entropy encoding unit 220 may entropy encode prediction syntax elements (e.g., motion information for inter-prediction or intra-mode information for intra-prediction) from mode selection unit 202. Entropy encoding unit 220 may perform one or more entropy encoding operations on the syntax elements, which are another example of video data, to generate entropy-encoded data. For example, entropy encoding unit 220 may perform a context-adaptive variable length coding (CAVLC) operation, a CABAC operation, a variable-to-variable (V2V) length coding operation, a syntax-based context-adaptive binary arithmetic coding (SBAC) operation, a Probability Interval Partitioning Entropy (PIPE) coding operation, an Exponential-Golomb encoding operation, or another type of entropy encoding operation on the data. In some examples, entropy encoding unit 220 may operate in bypass mode where syntax elements are not entropy encoded.

Video encoder 200 may output a bitstream that includes the entropy encoded syntax elements needed to reconstruct blocks of a slice or picture. In particular, entropy encoding unit 220 may output the bitstream

The operations described above are described with respect to a block. Such description should be understood as being operations for a luma coding block and/or chroma coding blocks. As described above, in some examples, the luma coding block and chroma coding blocks are luma and chroma components of a CU. In some examples, the luma coding block and the chroma coding blocks are luma and chroma components of a PU.

In some examples, operations performed with respect to a luma coding block need not be repeated for the chroma coding blocks. As one example, operations to identify a motion vector (MV) and reference picture for a luma coding block need not be repeated for identifying a MV and reference picture for the chroma blocks. Rather, the MV for the luma coding block may be scaled to determine the MV for the chroma blocks, and the reference picture may be the same. As another example, the intra-prediction process may be the same for the luma coding blocks and the chroma coding blocks.

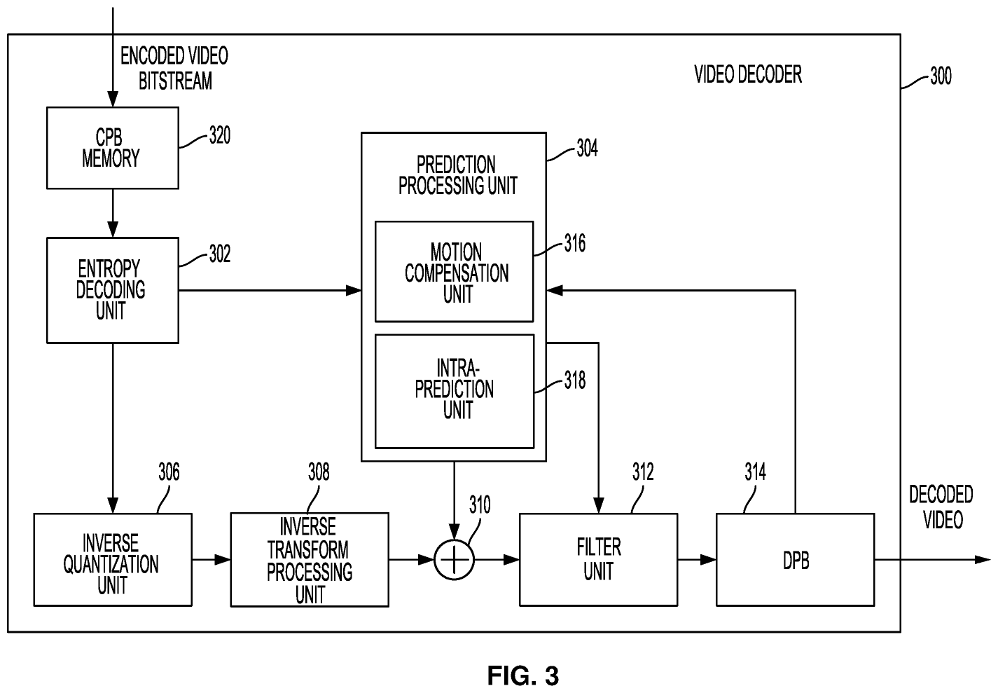

FIG. 3 illustrates a block diagram illustrating an example video decoder 300 that may perform the techniques of this disclosure. FIG. 3 is provided for purposes of explanation and is not limiting on the techniques as broadly exemplified and described in this disclosure. For purposes of explanation, this disclosure describes video decoder 300 is described according to the techniques of JEM and HEVC. However, the techniques of this disclosure may be performed by video coding devices that are configured to other video coding standards.

In the example of FIG. 3, video decoder 300 includes coded picture buffer (CPB) memory 320, entropy decoding unit 302, prediction processing unit 304, inverse quantization unit 306, inverse transform processing unit 308, reconstruction unit 310, filter unit 312, and decoded picture buffer (DPB) 314. Prediction processing unit 304 includes motion compensation unit 316 and intra-prediction unit 318. Prediction processing unit 304 may include addition units to perform prediction in accordance with other prediction modes. As examples, prediction processing unit 304 may include a palette unit, an intra-block copy unit (which may form part of motion compensation unit 316), an affine unit, a linear model (LM) unit, or the like. In other examples, video decoder 300 may include more, fewer, or different functional components.

CPB memory 320 may store video data, such as an encoded video bitstream, to be decoded by the components of video decoder 300. The video data stored in CPB memory 320 may be obtained, for example, from computer-readable medium 110 (FIG. 1). CPB memory 320 may include a CPB that stores encoded video data (e.g., syntax elements) from an encoded video bitstream. Also, CPB memory 320 may store video data other than syntax elements of a coded picture, such as temporary data representing outputs from the various units of video decoder 300. DPB 314 generally stores decoded pictures, which video decoder 300 may output and/or use as reference video data when decoding subsequent data or pictures of the encoded video bitstream. CPB memory 320 and DPB 314 may be formed by any of a variety of memory devices, such as dynamic random access memory (DRAM), including synchronous DRAM (SDRAM), magnetoresistive RAM (MRAM), resistive RAM (RRAM), or other types of memory devices. CPB memory 320 and DPB 314 may be provided by the same memory device or separate memory devices. In various examples, CPB memory 320 may be on-chip with other components of video decoder 300, or off-chip relative to those components.

Additionally or alternatively, in some examples, video decoder 300 may retrieve coded video data from memory 120 (FIG. 1). That is, memory 120 may store data as discussed above with CPB memory 320. Likewise, memory 120 may store instructions to be executed by video decoder 300, when some or all of the functionality of video decoder 300 is implemented in software to executed by processing circuitry of video decoder 300.

The various units shown in FIG. 3 are illustrated to assist with understanding the operations performed by video decoder 300. The units may be implemented as fixed-function circuits, programmable circuits, or a combination thereof. Similar to FIG. 2, fixed-function circuits refer to circuits that provide particular functionality, and are preset on the operations that can be performed. Programmable circuits refer to circuits that can programmed to perform various tasks, and provide flexible functionality in the operations that can be performed. For instance, programmable circuits may execute software or firmware that cause the programmable circuits to operate in the manner defined by instructions of the software or firmware. Fixed-function circuits may execute software instructions (e.g., to receive parameters or output parameters), but the types of operations that the fixed-function circuits perform are generally immutable. In some examples, the one or more of the units may be distinct circuit blocks (fixed-function or programmable), and in some examples, the one or more units may be integrated circuits.

Video decoder 300 may include ALUs, EFUs, digital circuits, analog circuits, and/or programmable cores formed from programmable circuits. In examples where the operations of video decoder 300 are performed by software executing on the programmable circuits, on-chip or off-chip memory may store instructions (e.g., object code) of the software that video decoder 300 receives and executes.

Entropy decoding unit 302 may receive encoded video data from the CPB and entropy decode the video data to reproduce syntax elements. Prediction processing unit 304, inverse quantization unit 306, inverse transform processing unit 308, reconstruction unit 310, and filter unit 312 may generate decoded video data based on the syntax elements extracted from the bitstream.

In general, video decoder 300 reconstructs a picture on a block-by-block basis. Video decoder 300 may perform a reconstruction operation on each block individually (where the block currently being reconstructed, i.e., decoded, may be referred to as a “current block”).

Entropy decoding unit 302 may entropy decode syntax elements defining quantized transform coefficients of a quantized transform coefficient block, as well as transform information, such as a quantization parameter (QP) and/or transform mode indication(s). Inverse quantization unit 306 may use the QP associated with the quantized transform coefficient block to determine a degree of quantization and, likewise, a degree of inverse quantization for inverse quantization unit 306 to apply. Inverse quantization unit 306 may, for example, perform a bitwise left-shift operation to inverse quantize the quantized transform coefficients. Inverse quantization unit 306 may thereby form a transform coefficient block including transform coefficients.

After inverse quantization unit 306 forms the transform coefficient block, inverse transform processing unit 308 may apply one or more inverse transforms to the transform coefficient block to generate a residual block associated with the current block. For example, inverse transform processing unit 308 may apply an inverse DCT, an inverse integer transform, an inverse Karhunen-Loeve transform (KLT), an inverse rotational transform, an inverse directional transform, or another inverse transform to the coefficient block.

Furthermore, prediction processing unit 304 generates a prediction block according to prediction information syntax elements that were entropy decoded by entropy decoding unit 302. For example, if the prediction information syntax elements indicate that the current block is inter-predicted, motion compensation unit 316 may generate the prediction block. In this case, the prediction information syntax elements may indicate a reference picture in DPB 314 from which to retrieve a reference block, as well as a motion vector identifying a location of the reference block in the reference picture relative to the location of the current block in the current picture. Motion compensation unit 316 may generally perform the inter-prediction process in a manner that is substantially similar to that described with respect to motion compensation unit 224 (FIG. 2).

As another example, if the prediction information syntax elements indicate that the current block is intra-predicted, intra-prediction unit 318 may generate the prediction block according to an intra-prediction mode indicated by the prediction information syntax elements. Again, intra-prediction unit 318 may generally perform the intra-prediction process in a manner that is substantially similar to that described with respect to intra-prediction unit 226 (FIG. 2). Intra-prediction unit 318 may retrieve data of neighboring samples to the current block from DPB 314.

Reconstruction unit 310 may reconstruct the current block using the prediction block and the residual block. For example, reconstruction unit 310 may add samples of the residual block to corresponding samples of the prediction block to reconstruct the current block.

Filter unit 312 may perform one or more filter operations on reconstructed blocks. For example, filter unit 312 may perform deblocking operations to reduce blockiness artifacts along edges of the reconstructed blocks. Operations of filter unit 312 are not necessarily performed in all examples.

Video decoder 300 may store the reconstructed blocks in DPB 314. As discussed above, DPB 314 may provide reference information, such as samples of a current picture for intra-prediction and previously decoded pictures for subsequent motion compensation, to prediction processing unit 304. Moreover, video decoder 300 may output decoded pictures from DPB for subsequent presentation on a display device, such as display device 118 of FIG. 1.

It will be appreciated that an example quadtree binary tree (QTBT) structure may have a corresponding coding tree unit (CTU). The root node of a QTBT structure corresponding to a CTU may have four child nodes at the first level of the QTBT structure, each of which may be partitioned according to quadtree partitioning. That is, nodes of the first level are either leaf nodes (having no child nodes) or have four child nodes. The example of QTBT structure 600 represents such nodes as including the parent node and child nodes having solid lines for branches. If nodes of the first level are not larger than the maximum allowed binary tree root node size (MaxBTSize), they can be further partitioned by respective binary trees. The binary tree splitting of one node can be iterated until the nodes resulting from the split reach the minimum allowed binary tree leaf node size (MinBTSize) or the maximum allowed binary tree depth (MaxBTDepth). The example of QTBT structure 600 represents such nodes as having dashed lines for branches. The binary tree leaf node is referred to as a coding unit (CU), which is used for prediction (e.g., intra-picture or inter-picture prediction) and transform, without any further partitioning. As discussed above, CUs may also be referred to as “video blocks” or “blocks.”

In one example of the QTBT partitioning structure, the CTU size is set as 128×128 (luma samples and two corresponding 64×64 chroma samples), the MinQTSize is set as 16×16, the MaxBTSize is set as 64×64, the MinBTSize (for both width and height) is set as 4, and the MaxBTDepth is set as 4. The quadtree partitioning is applied to the CTU first to generate quad-tree leaf nodes. The quadtree leaf nodes may have a size from 16×16 (i.e., the MinQTSize) to 128×128 (i.e., the CTU size). If the leaf quadtree node is 128×128, it will not be further split by the binary tree, since the size exceeds the MaxBTSize (i.e., 64×64, in this example). Otherwise, the leaf quadtree node will be further partitioned by the binary tree. Therefore, the quadtree leaf node is also the root node for the binary tree and has the binary tree depth as 0. When the binary tree depth reaches MaxBTDepth (4, in this example), no further splitting is permitted. When the binary tree node has width equal to MinBTSize (4, in this example), it implies no further horizontal splitting is permitted. Similarly, a binary tree node having a height equal to MinBTSize implies no further vertical splitting is permitted for that binary tree node. As noted above, leaf nodes of the binary tree are referred to as CUs, and are further processed according to prediction and transform without further partitioning.

The CU structure and motion vector prediction in HEVC will be reviewed in this section. In HEVC, the largest coding unit in a slice is called a coding tree block (CTB) or coding tree unit (CTU). A CTB contains a quad-tree, the nodes of which are coding units.

The size of a CTB can range from 16×16 to 64×64 in the HEVC main profile (although technically 8×8 CTB sizes can be supported). A coding unit (CU) could be the same size of a CTB and as small as 8×8. Each coding unit is coded with one mode. When a CU is inter coded, the CU may be further partitioned into 2 or 4 prediction units (PUs) or become just one PU when further partition doesn't apply. When two PUs are present in one CU, they can be half size rectangles or two rectangle sizes with ¼ or ¾ size of the CU.

When the CU is inter coded, one set of motion information is present for each PU. In addition, each PU is coded with a unique inter-prediction mode to derive the set of motion information.

In the HEVC standard, there are two inter prediction modes, named merge (skip is considered as a special case of merge) and advanced motion vector prediction (AMVP) modes, respectively, for a prediction unit (PU).

In either AMVP or merge mode, a motion vector (MV) candidate list is maintained for multiple motion vector predictors. The motion vector(s), as well as reference indices in the merge mode, of the current PU are generated by taking one candidate from the MV candidate list.

The MV candidate list contains up to 5 candidates for the merge mode and only two candidates for the AMVP mode. A merge candidate may contain a set of motion information, e.g., motion vectors corresponding to both reference picture lists (list 0 and list 1) and the reference indices. If a merge candidate is identified by a merge index, the reference pictures are used for the prediction of the current blocks, as well as the associated motion vectors are determined. However, under AMVP mode for each potential prediction direction from either list 0 or list 1, a reference index is explicitly signaled, together with an MV predictor (MVP) index to the MV candidate list since the AMVP candidate contains only a motion vector. In AMVP mode, the predicted motion vectors can be further refined.

As can be seen above, a merge candidate corresponds to a full set of motion information while an AMVP candidate contains just one motion vector for a specific prediction direction and reference index.

The candidates for both modes are derived similarly from the same spatial and temporal neighboring blocks.

Temporal motion vector prediction in HEVC will be discussed in this section. A temporal motion vector predictor (TMVP) candidate, if enabled and available, is added into the MV candidate list after spatial motion vector candidates. The process of motion vector derivation for TMVP candidate is the same for both merge and AMVP modes. However, the target reference index for the TMVP candidate in the merge mode is always set to 0.

The primary block location for TMVP candidate derivation is the bottom right block outside of the collocated PU, to compensate the bias to the above and left blocks used to generate spatial neighboring candidates. However, if that block is located outside of the current CTB row or motion information is not available, the block is substituted with a center block of the PU.

A motion vector for TMVP candidate is derived from the co-located PU of the co-located picture, indicated in the slice level. The motion vector for the co-located PU is called collocated MV.

Similar to temporal direct mode in AVC, to derive the TMVP candidate motion vector, the co-located MV may be scaled to compensate the temporal distance differences.

Motion vector prediction in merge/skip mode will now be discussed. For the skip mode and merge mode, a merge index is signaled to indicate which candidate in the merging candidate list is used. No inter prediction indicator, reference index, or MVD is transmitted. Two types of merging candidates are considered in merge mode: spatial motion vector predictor (SMVP) and temporal motion vector predictor (TMVP). For SMVP derivation, a maximum of four merge candidates are selected among candidates that are located in positions. The order of derivation is A₁→B₁→B₀→A₀→(B₂). Position B₂ is considered only when any PU of position A₁, B₁, B₀, A₀ is not available or is intra coded or the total number of candidates, after pruning, from positions A₁, B₁, B₀, A₀ is less than four.

In the derivation of a TMVP, a scaled motion vector is derived based on co-located PU belonging to one of the reference pictures of current picture within the signaled reference picture list. The reference picture list to be used for derivation of the co-located PU is explicitly signalled in the slice header. The scaled motion vector for temporal merge candidate is obtained with the scaled motion vector of the co-located PU using the picture order count (POC) distances, tb and td, where tb is defined to be the POC difference between the reference picture of the current picture and the current picture and td is defined to be the POC difference between the reference picture of the co-located picture and the co-located picture. The reference picture index of temporal merge candidate is set equal to zero. A practical realization of the scaling process is described in the HEVC draft specification. For a B-slice, two motion vectors, one is for reference picture list 0 and the other is for reference picture list 1, are obtained and combined to make the bi-predictive merge candidate.

The position of co-located PU is selected between two candidate positions, C and H. If PU at position H is not available, or is intra coded, or is outside of the current CTU row, position C is used. Otherwise, position H is used for the derivation of the temporal merge candidate.

Besides SMVPs and TMVPs, there are two additional types of synthetic merge candidates: combined bi-predictive MVP and zero MVP. Combined bi-predictive MVP are generated by utilizing SMVP and TMVP. Combined bi-predictive merge candidate is used for B-Slice only. For example, two candidates in the original merge candidate list, which have mvL0 and refld×L0 or mvL1 and refld×L1, are used to create a combined bi-predictive merge candidate.

In the process of candidate selection, duplicated candidates having the same motion parameters as the previous candidate in the processing order are removed from the candidate list. This process is defined as a pruning process. Also, candidates inside the same merge estimation region (MER) are not considered, in order to help parallel merge processing. Redundant partition shape is avoided in order to not emulate a virtual 2N×2N partition.

Between each generation step, the derivation process is stopped if the number of candidates reaches to maximum number of merge candidates (MaxNumMergeCand). In the current common test condition, MaxNumMergeCand is set equal to five. Since the number of candidates is constant, index of best merge candidate is encoded using truncated unary binarization (TU).

Other aspects of motion prediction in HEVC will now be discussed. Several aspects of merge and AMVP modes are worth mentioning as follows.

Motion Vector Scaling:

It is assumed that the value of motion vectors is proportional to the distance of pictures in the presentation time. A motion vector associates two pictures, the reference picture, and the picture containing the motion vector (namely the containing picture). When a motion vector is utilized to predict the other motion vector, the distance of the containing picture and the reference picture is calculated based on the Picture Order Count (POC) values.

For a motion vector to be predicted, both its associated containing picture and reference picture may be different. Therefore, a new distance (based on POC) is calculated, and the motion vector is scaled based on these two POC distances. For a spatial neighboring candidate, the containing pictures for the two motion vectors are the same, while the reference pictures are different. In HEVC, motion vector scaling applies to both TMVP and AMVP for spatial and temporal neighboring candidates.

Artificial Motion Vector Candidate Generation:

If a motion vector candidate list is not complete, artificial motion vector candidates are generated and inserted at the end of the list until it will have all candidates.

In merge mode, there are two types of artificial MV candidates: combined candidate derived only for B-slices and zero candidates used only for AMVP if the first type doesn't provide enough artificial candidates.

For each pair of candidates that are already in the candidate list and have necessary motion information, bi-directional combined motion vector candidates are derived by a combination of the motion vector of the first candidate referring to a picture in the list 0 and the motion vector of a second candidate referring to a picture in the list 1.

Pruning Process for Candidate Insertion:

Candidates from different blocks may happen to be the same, which decreases the efficiency of a merge/AMVP candidate list. A pruning process is applied to solve this problem. It compares one candidate against the others in the current candidate list to avoid inserting identical candidate in certain extent. To reduce the complexity, only limited numbers of pruning process is applied instead of comparing each potential one with all the other existing ones.

Non-adjacent spatial neighboring candidates will now be discussed. A non-adjacent spatial merge candidate prediction technique is proposed for the future video coding standards, such as VVC, to increase the size of merge candidate list. Video encoder 200 and video decoder 300 may fill the merge candidate list from non-adjacent spatial neighboring blocks.

The design of HEVC/JEM/VVC/VTM/BMS may have the following problems: For generating motion vector predictor list, a pruning process is used to avoid adding duplicate candidates. When the motion vector predictor list increases in size, more and more pruning operations are used, which increases the complexity of video encoder 200 and video decoder 300.

The techniques of this disclosure may reduce the complexity of motion vector predictor list generation through a fast pruning algorithm. The techniques of this disclosure may be used in merge candidates list generation. The techniques of this disclosure may also be used in the field of other motion vector predictor list generation, such as AMVP list and affine MVP list. The techniques of this disclosure may also be used in the field of intra most probable mode (MPM) list generation.

Group Based Pruning

When video encoder 200 and/or video decoder 300 adds one predictor into a list, video encoder 200 and/or video decoder 300 may perform a pruning operation between a portion of the candidates, and may avoid comparing all of the candidates in the list to reduce complexity.

In one example, video encoder 200 and/or video decoder 300 may divide the candidates into different groups, and perform pruning inside the same group. In another example, video encoder 200 and/or video decoder 300 may divide the candidates into different groups, and may preform pruning inside the same group and/or between some of the different groups.

Grouping:
1. For example, the motion vector predictors candidates for inter prediction (or most probable mode (MPM) for intra prediction) can be divided into different groups according to the distance to the current coding block.
   a. For example, the candidates are divided into different groups based on the vertical and horizontal distance to the current coding block as function (1);

Group_i|×<=threshold_group_i_x&&y<=threshold_group_i_y (1)

For example, the basic block unit is 4×4, the group_i is the candidates with the threshold_group_i_x and threshold_group_i_y is equal to (i−1)×32. Video encoder 200 and/or video decoder 300 may add the candidates from the group which is nearest to the current coding block at first until video encoder 200 and/or video decoder 300 adds enough candidates to reach the maximum number of candidates defined for the list.

As another example, video encoder 200 and/or video decoder 300 divides the candidates into different groups based on the vertical and horizontal distance to the current coding block as function (2);

Group_i|(x²+y²)<=threshold_group_i (2)

For example, the motion vector predictors candidates for inter prediction can be divided into different groups based on prediction direction, and/or prediction mode, and/or reference POC. Video encoder 200 and/or video decoder 300 includes the candidates with same feature into the same group.

Pruning Number

As one example, video encoder 200 and/or video decoder 300 may perform pruning in the same group. For example, define N<number of candidates in this group. When checking a new candidate, video encoder 200 and/or video decoder 300 only perform pruning with the available candidates already in the list (<=N).

As another example, video encoder 200 and/or video decoder 300 perform pruning between different groups. For example, define Mᵢ to be the number for pruning in the Groupᵢ. When checking a new candidate for the current group, video encoder 200 and/or video decoder 300 perform pruning between the candidates in the current group with the Mᵢ candidates in the Groupᵢ.

As another example, video encoder 200 and/or video decoder 300 perform pruning depending on the position of the current candidate and the position of the candidates already considered to be added to the list (candidates with a smaller number). When two candidates are close to each other, pruning may be applied. The closeness may be defined as Euclidean distance or distance on vertical or horizontal or another distance measure.

In one example, video encoder 200 and/or video decoder 300 perform pruning between the candidates which are close to the current one. For example, when checking candidate 20, video encoder 200 and/or video decoder 300 perform pruning with candidate 9 and candidate 18 which are the closest to candidate 20. As another example, when checking candidate 13, video encoder 200 and/or video decoder 300 perform pruning with all or a subset of candidates 1, 4, 10 and 14 which are the closest to candidate 13 or video encoder 200 and/or video decoder 300 perform pruning with the first close candidate in the process order to further reduce the complexity.

Motion Vector Predictor Pruning

Video encoder 200 and/or video decoder 300 may compare the reference direction, and/or reference index, and/or POC, and/or motion vector (with/without scaling) between two motion vector predictors. If one of these characteristics are the same, video encoder 200 and/or video decoder 300 do not add this motion vector predictor to the candidate list.

Parameters Coding

In one example, the number of groups, the number of candidates in each group, the number of candidates for pruning in the group, and the threshold of different group can be predefined, fixed, or dependent on one or more of the CTU size, and/or current coding block size, and/or the position of the candidates, and/or prediction mode.

For example, the number of groups, the number of candidates in different groups, the number of candidates for pruning in the group, and the threshold of different group can be signaled via the sequence parameter set (SPS), picture parameter set (PPS), at the slice header, or at the CU level.

In prior approaches, intra prediction coding using most probable modes (MPM) may be practiced. For example, in HEVC and VVC (JVET Draft 2), a list of 3 MPMs is constructed from the intra prediction modes of left and above blocks. The disadvantage of such method is more modes (all intra modes that are not MPM) fall under remaining modes that are coded with more bits. Some methods have been proposed to extend the number of MPMs to more than three entries (e.g., six MPM modes). However, the construction of such MPM lists with more entries may require more checks and conditions, which may result in more complexity in implementation.

An example of the 3 MPM method is reproduced below from JVET Draft 2. The syntax element indicating the MPM index used is coded using unary coding, and the remaining modes are bypass coded using 6 bits.

8.2.2 Derivation Process for Luma Intra Prediction Mode

Input to this process are:
a luma location (xCb, yCb) specifying the top-left sample of the current luma coding block relative to the top-left luma sample of the current picture,
a variable cbWidth specifying the width of the current coding block in luma samples,
a variable cbHeight specifying the height of the current coding block in luma samples.

In this process, the luma intra prediction mode IntraPredModeY[xCb][yCb] is derived.
Table 8-1 specifies the value for the intra prediction mode IntraPredModeY[xCb][yCb] and the associated names.

TABLE 8-1
Specification of intra prediction mode and associated names

| Intra prediction | |
|---|---|
| mode | Associated name |
| 0 | INTRA_PLANAR |
| 1 | INTRA_DC |
| 2 . . . 66 | INTRA_ANGULAR2 . . . INTRA_ANGULAR66 |
| 77 | INTRA_CCLM |

NOTE -:
The intra prediction mode INTRA_CCLM is only applicable to chroma components.

IntraPredModeY[xCb][yCb] is derived by the following ordered steps:
1. The neighbouring locations (xNbA, yNbA) and (xNbB, yNbB) are set equal to (xCb−1, yCb) and (xCb, yCb−1), respectively.
2. For X being replaced by either A or B, the variables candIntraPredModeX are derived as follows:
   The availability derivation process for a block as specified in clause 6.4.X [Ed. (BB): Neighbouring blocks availability checking process tbd] is invoked with the location (xCurr, yCurr) set equal to (xCb, yCb) and the neighbouring location (xNbY, yNbY) set equal to (xNbX, yNbX) as inputs, and the output is assigned to availableX.
   The candidate intra prediction mode candIntraPredModeX is derived as follows:
      If one or more of the following conditions are true, candIntraPredModeX is set equal to INTRA_DC.
         The variable availableX is equal to FALSE.
         CuPredMode[xNbX][yNbX] is not equal to MODE_INTRA.
         X is equal to B and yCb−1 is less than ((yCb>>CtbLog2SizeY)<<CtbLog2SizeY).
      Otherwise, candIntraPredModeX is set equal to IntraPredModeY[xNbX][yNbX].
3. The candModeList[x] with x=0 . . . 2 is derived as follows:
   If candIntraPredModeB is equal to candIntraPredModeA, the following applies:
      If candIntraPredModeA is less than 2 (i.e., equal to INTRA_PLANAR or INTRA_DC), candModeList[x] with x=0 . . . 2 is derived as follows:

candModeList[0]=INTRA_PLANAR (8-1)

candModeList[1]=INTRA_DC (8-2)

candModeList[2]=INTRA_ANGULAR50 (8-3)
Otherwise, candModeList[x] with x=0 . . . 2 is derived as follows:

candModeList[0]=candIntraPredModeA (8-4)

candModeList[1]=2+((candIntraPredModeA+61)%64) (8-5)

candModeList[2]=2+(((candIntraPredModeA−1)%64) (8-6)
Otherwise (candIntraPredModeB is not equal to candIntraPredModeA), the following applies:
candModeList[0] and candModeList[1] are derived as follows:

candModeList[0]=candIntraPredModeA (8-7)

candModeList[1]=candIntraPredModeB (8-8)
If neither of candModeList[0] and candModeList[1] is equal to INTRA_PLANAR, candModeList[2] is set equal to INTRA_PLANAR,
Otherwise, if neither of candModeList[0] and candModeList[1] is equal to INTRA_DC, candModeList[2] is set equal to INTRA_DC,
Otherwise, candModeList[2] is set equal to INTRA_ANGULAR50.
4. IntraPredModeY[xCb][yCb] is derived by applying the following procedure:
   If intra_luma_mpm_flag[xCb][yCb] is equal to 1, the IntraPredModeY[xCb][yCb] is set equal to candModeList[intra_luma_mpm_idx[xCb][yCb] ].
   Otherwise, IntraPredModeY[xCb][yCb] is derived by applying the following ordered steps:
   1. The array candModeList[x], x=0 . . . 2 is modified by the following ordered steps:
      i. When candModeList[0] is greater than candModeList[1], both values are swapped as follows:

(candModeList[0],candModeList[1])=Swap(candModeList[0],candModeList[1]) (8-9)
ii. When candModeList[0] is greater than candModeList[2], both values are swapped as follows:

(candModeList[0],candModeList[2])=Swap(candModeList[0],candModeList[2]) (8-10)
iii. When candModeList[1] is greater than candModeList[2], both values are swapped as follows:

(candModeList[1],candModeList[2])=Swap(candModeList[1],candModeList[2]) (8-11)
2. IntraPredModeY[xCb][yCb] is derived by the following ordered steps:
   i. IntraPredModeY[xCb][yCb] is set equal to intra_luma_mpm_remainder[xCb][yCb].
   ii. For i equal to 0 to 2, inclusive, when IntraPredModeY[xCb] [yCb] is greater than or equal to candModeList[i], the value of IntraPredModeY[xCb][yCb] is incremented by one.

The variable IntraPredModeY[x][y] with x=xCb . . . xCb+cbWidth−1 and y=yCb . . . yCb+cbHeight−1 is set to be equal to IntraPredModeY[xCb][yCb].

In view of the above, several improvements to MPM coding for video are discussed herein. For example, each of the following concepts may be applied independently or combined together in any number, order, or combination.

1. Determining a set of most probable modes, such that only a subset of the MPMs are unique. In some embodiments, only a certain number of entries, N, may be tested to be unique and the rest of the entries may or may not be unique.

2. Constructing an MPM list from the set of MPMs. In some embodiments, the MPM list may be directly constructed without creating an explicit set of MPMs. In other embodiments, the MPM list may be constructed from one or more neighboring modes and one or more default set of modes. The MPM list generation may be constrained to be such that a subset of the indices corresponds to unique modes; e.g., the MPMs corresponding to the first three indices of the MPM list containing six MPM is restricted to be unique. The other MPM modes may or may not be unique.

In some embodiments, the numbers of MPMs in the list may be dependent on the block size, block characteristics, block neighborhood or other factors; in such cases, the number of MPMs may be predetermined at the encoder and decoder based on the various block features, or may be signalled in the bitstream.

In some embodiments, the number of MPMs constrained to be unique may be dependent on the block size, block characteristics, block neighborhood or other factors; in such cases, the number of MPMs may be predetermined at the encoder and decoder based on the various block features, or may be signalled in the bitstream.

3. Ensuring that one or more of the unique MPMs are sorted, thereby producing another list of partially sorted MPMs.

4. Re-indexing the remaining modes so that only the sorted MPMs are considered in the re-indexing. Re-indexing may involve renumbering the mode number using an algorithm such that syntax element used to specify the remaining modes applies to a unique mode.

5. In some embodiments, one or more of the MPMs are obtained by adding or subtracting values of two other intra modes, or based on other operations.

6. In one example embodiment, let N be the total number of modes (including directional/angular and non-directional modes) that may be used for a particular block. Let Nmpm be the number of modes included in the MPM list. Let K (<=N and typically <Nmpm) be the number of modes out of N that are identified such that the remaining N−K modes are re-indexed and signalled. Re-indexing such may allow signalling the N−K with a simpler method than signalling N−Nmpm modes. For example, an index to the N−Nmpm remaining modes may be signalled using a truncated binary codeword; the parsing of a truncated binary codeword may involve conditional checks which introduces complexity in the parsing. The value of K may be chosen such that N−K is a power of 2 and the index to the N−K modes may be signalled by a fixed-length codeword (with length log 2[N−K] bits). In such examples, the value of Nmpm may be optimized to increase the coding efficiency, hence, the value of N−Nmpm may not be a power of 2.

In some embodiments the K modes are chosen from the MPM list.

In some embodiments, re-indexing the N−K modes may involve sorting the K modes. This is a partial sorting step (with K candidates) as opposed to full sorting of Nmpm modes.

When it is known that K1 modes are always present in the MPM, only additional K-K1 modes are identified to perform the re-indexing. The K-K1 modes may be chosen from a subset of the MPMs.

In some embodiments, the value of N, Nmpm, K and K1 may be 67, 6, 3 and 2, respectively (67 modes may be used for a block, six modes in the MPM list, three modes to be identified, two modes, e.g., PL, DC, known to be always present in the MPM list).

In some cases, K1 may be zero and K candidates may be chosen as the first K candidates in the MPM.

In some embodiments K1 may represent modes that are never present in the MPM or may not be used to code the current block.

7. In some embodiments, when one or more modes may be known to be present in the MPM, the re-indexing may be simplified by using this information. For example, when PL and DC modes (mode values 0 and 1, respectively) are always present in the MPM list, the re-indexing may involve the selection of just one additional mode, M, from the MPM list. The remaining modes are re-indexed using modes 0, 1 and M.

In some embodiments, M may be chosen as an i-th entry in the MPM when the value of i is pre-determined, signalled in the bitstream, or determined based on the block characteristics, mode, etc.

In one alternative, M may be chosen as the maximum of the first three modes in the MPM list.

In some embodiments, M may be chosen as a function of three modes in the MPM list, where the modes are chosen from pre-determined positions in the MPM list. E.g., median value of the first, second and last entries in the MPM list.

In another alternative, M may be chosen by a method depending on one or more of the following: block size parameters, mode value of neighbouring blocks or other characteristics of the current block or neighbouring blocks. Some examples of such a choice are given below:

When the left neighbouring block (or above) is known to be coded using an intra mode that is neither Planar nor DC, the value of M may be chosen to be the intra mode used to code the left (or above) neighbouring block.

When it is known that both left and neighbouring block are coded using an intra mode that is neither Planar nor DC, the value of M may be chosen to be one of the intra modes known to be added to the MPM list, such has INTRA_ANGULAR50 (vertical direction).

When it is known that only one of the left or above blocks is coded using an intra mode that is neither Planar nor DC, the M may be set equal to the maximum of left and above modes, thus choosing the mode that is neither PL nor DC.

In some embodiments, mode values representative of left and above blocks may be preset to some values (e.g., Planar mode) and modified only when the respective block (left or above) is present and is coded with an intra mode. In such cases, the determination of M may be conducted based on the preset values when a corresponding block is not present or not coded using intra mode.

In other embodiments, the location of the block may also restrict the availability of the blocks (e.g., at the top CTU boundary, above blocks may be regarded as unavailable) and the mode values representative of certain blocks may be set to preset values.

8. Coding video using one or more of the methods presented above.

For example, a discussion of how some of the above embodiments may be applied follows. The changes from the JVET Draft 2 luma intra mode code derivation reproduced above are highlighted in bold.

8.2.2 Derivation Process for Luma Intra Prediction Mode

Input to this process are:
a luma location (xCb, yCb) specifying the top-left sample of the current luma coding block relative to the top-left luma sample of the current picture,
a variable cbWidth specifying the width of the current coding block in luma samples,
a variable cbHeight specifying the height of the current coding block in luma samples.

In this process, the luma intra prediction mode IntraPredModeY[xCb][yCb] is derived.
Table 8-1 Specifies the value for the intra prediction mode IntraPredModeY[xCb][yCb] and the associated names.

TABLE 8-1
Specification of intra prediction mode and associated names

| Intra prediction | |
|---|---|
| mode | Associated name |
| 0 | INTRA_PLANAR |
| 1 | INTRA_DC |
| 2 . . . 66 | INTRA_ANGULAR2 . . . INTRA_ANGULAR66 |
| 77 | INTRA_CCLM |

NOTE -:
The intra prediction mode INTRA_CCLM is only applicable to chroma components.

IntraPredModeY[xCb][yCb] is derived by the following ordered steps:
5. The neighbouring locations (xNbA, yNbA) and (xNbB, yNbB) are set equal to (xCb−1, yCb) and (xCb, yCb−1), respectively.
6. For X being replaced by either A or B, the variables candIntraPredModeX are derived as follows:
   The availability derivation process for a block as specified in clause 6.4.X [Ed. (BB): Neighbouring blocks availability checking process tbd] is invoked with the location (xCurr, yCurr) set equal to (xCb, yCb) and the neighbouring location (xNbY, yNbY) set equal to (xNbX, yNbX) as inputs, and the output is assigned to availableX.
   The candidate intra prediction mode candIntraPredModeX is derived as follows:
      If one or more of the following conditions are true, candIntraPredModeX is set equal to INTRA_DC.
         The variable availableX is equal to FALSE.
         CuPredMode[xNbX][yNbX] is not equal to MODE_INTRA.
         X is equal to B and yCb−1 is less than ((yCb>>CtbLog2SizeY)<<CtbLog2SizeY).
      Otherwise, candIntraPredModeX is set equal to IntraPredModeY[xNbX][yNbX].
7. The candModeList[x] with x=0 . . . 5 is derived as follows:
   If candIntraPredModeB is equal to candIntraPredModeA, the following applies:
      If candIntraPredModeA is less than 2 (i.e., equal to INTRA_PLANAR or INTRA_DC), candModeList[x] with x=0 . . . 2 is derived as follows:

candModeList[0]=INTRA_PLANAR (8-1)

candModeList[1]=INTRA_DC (8-2)

candModeList[2]=INTRA_ANGULAR50 (8-3)

candModeList[3]=INTRA_ANGULAR18 (8-x)

candModeList[4]=INTRA_ANGULAR2 (8-x)

candModeList[5]=INTRA_ANGULAR34 (8-x)
Otherwise, candModeList[x] with x=0 . . . 2 is derived as follows:

candModeList[0]=candIntraPredModeA (8-4)

candModeList[1]=2+((candIntraPredModeA+62)%64) (8-5)

candModeList[2]=2+((candIntraPredModeA−1)%64) (8-6)

candModeList[3]=INTRA_PLANAR (8-x)

candModeList[4]=INTRA_DC (8-x)

candModeList[5]=2+((candIntraPredModeA+61)%64) (8-x)
Otherwise (candIntraPredModeB is not equal to candIntraPredModeA), the following applies:
   candModeList[0] and candModeList[1] are derived as follows:

candModeList[0]=candIntraPredModeA (8-7)

candModeList[1]=candIntraPredModeB (8-8)

maxCandMode=max(candIntraPredModeA,candIntraPredModeB)

mode3=2+((maxCandMode+62)%64)

mode4=2+((maxCandMode−1)%64)

mode5=2+((maxCandMode+61)%64)
If neither of candModeList[0] and candModeList[1] is equal to INTRA_PLANAR, candModeList[i], for i=2, 3, 4 and 5 are set equal to INTRA_PLANAR, mode3, mode4 and mode5, respectively,
Otherwise, if neither of candModeList[0] and candModeList[1] is equal to INTRA_DC, candModeList[i], for i=2, 3, 4 and 5 are set equal to INTRA_DC, mode3, mode4 and mode5, respectively,
Otherwise, candModeList[i], for i=2, 3, 4 and 5 are set equal to INTRA_ANGULAR50, INTRA_ANGULAR18, INTRA_ANGULAR2 and INTRA_ANGULAR34, respectively.
8. IntraPredModeY[xCb][yCb] is derived by applying the following procedure:
   If intra_luma_mpm_flag[xCb][yCb] is equal to 1, the IntraPredModeY[xCb][yCb] is set equal to candModeList[intra_luma_mpm_idx[xCb][yCb] ].
   Otherwise, IntraPredModeY[xCb][yCb] is derived by applying the following ordered steps:
   3. The array candModeList[x], x=0 . . . 2 is modified by the following ordered steps:
      i. When candModeList[0] is greater than candModeList[1], both values are swapped as follows:

(candModeList[0],candModeList[1])=Swap(candModeList[0],candModeList[1]) (8-9)
ii. When candModeList[0] is greater than candModeList[2], both values are swapped as follows:

(candModeList[0],candModeList[2])=Swap(candModeList[0],candModeList[2]) (8-10)
iii. When candModeList[1] is greater than candModeList[2], both values are swapped as follows:

(candModeList[1],candModeList[2])=Swap(candModeList[1],candModeList[2]) (8-11)
4. IntraPredModeY[xCb][yCb] is derived by the following ordered steps:
   i. IntraPredModeY[xCb][yCb] is set equal to intra_luma_mpm_remainder[xCb][yCb].
   ii. For i equal to 0 to 2, inclusive, when IntraPredModeY[xCb] [yCb] is greater than or equal to candModeList[i], the value of IntraPredModeY[xCb][yCb] is incremented by one.

The variable IntraPredModeY[x][y] with x=xCb . . . xCb+cbWidth−1 and y=yCb . . . yCb+cbHeight−1 is set to be equal to IntraPredModeY[xCb][yCb].

In another example embodiment illustrated below, modifications may be made to the JVET Draft 2 luma intra mode code derivation as highlighted below in bold.

8.2.2 Derivation Process for Luma Intra Prediction Mode

Input to this process are:
a luma location (xCb, yCb) specifying the top-left sample of the current luma coding block relative to the top-left luma sample of the current picture,
a variable cbWidth specifying the width of the current coding block in luma samples,
a variable cbHeight specifying the height of the current coding block in luma samples.

In this process, the luma intra prediction mode IntraPredModeY[xCb][yCb] is derived.
Table 8-1 specifies the value for the intra prediction mode IntraPredModeY[xCb][yCb] and the associated names.

TABLE 8-1
Specification of intra prediction mode and associated names

| Intra prediction | |
|---|---|
| mode | Associated name |
| 0 | INTRA_PLANAR |
| 1 | INTRA_DC |
| 2 . . . 66 | INTRA_ANGULAR2 . . . INTRA_ANGULAR66 |
| 77 | INTRA_CCLM |

NOTE -:
The intra prediction mode INTRA_CCLM is only applicable to chroma components.

IntraPredModeY[xCb][yCb] is derived by the following ordered steps:
1. The neighbouring locations (xNbA, yNbA) and (xNbB, yNbB) are set equal to (xCb−1, yCb) and (xCb, yCb−1), respectively.
2. For X being replaced by either A or B, the variables candIntraPredModeX are derived as follows:
   The availability derivation process for a block as specified in clause 6.4.X [Ed. (BB): Neighbouring blocks availability checking process tbd] is invoked with the location (xCurr, yCurr) set equal to (xCb, yCb) and the neighbouring location (xNbY, yNbY) set equal to (xNbX, yNbX) as inputs, and the output is assigned to availableX.
   The candidate intra prediction mode candIntraPredModeX is derived as follows:
      If one or more of the following conditions are true, candIntraPredModeX is set equal to INTRA_DC.
         The variable availableX is equal to FALSE.
         CuPredMode[xNbX][yNbX] is not equal to MODE_INTRA.
         X is equal to B and yCb−1 is less than ((yCb>>CtbLog2SizeY)<<CtbLog2SizeY).
      Otherwise, candIntraPredModeX is set equal to IntraPredModeY[xNbX][yNbX].
3. The candModeList[x] with x=0 . . . 5 is derived as follows:
   If candIntraPredModeB is equal to candIntraPredModeA, the following applies:
      If candIntraPredModeA is less than 2 (i.e., equal to INTRA_PLANAR or INTRA_DC), candModeList[x] with x=0 . . . 2 is derived as follows:

candModeList[0]=INTRA_PLANAR (8-1)

candModeList[1]=INTRA_DC (8-2)

candModeList[2]=INTRA_ANGULAR50 (8-3)

candModeList[3]=INTRA_ANGULAR18 (8-x)

candModeList[4]=INTRA_ANGULAR2 (8-x)

candModeList[5]=INTRA_ANGULAR34 (8-x)
Otherwise, candModeList[x] with x=0 . . . 2 is derived as follows:

candModeList[0]=candIntraPredModeA (8-4)

candModeList[1]=2+((candIntraPredModeA+62)%64) (8-5)

candModeList[2]=2+((candIntraPredModeA−1)%64) (8-6)

candModeList[3]=INTRA_PLANAR (8-x)

candModeList[4]=INTRA_DC (8-x)

candModeList[5]=2+((candIntraPredModeA+61)%64) (8-x)
Otherwise (candIntraPredModeB is not equal to candIntraPredModeA), the following applies:
   candModeList[0] and candModeList[1] are derived as follows:

candModeList[0]=candIntraPredModeA (8-7)

candModeList[1]=candIntraPredModeB (8-8)

maxCandMode=max(candIntraPredModeA,candIntraPredModeB)

mode3=2+((maxCandMode+62)%64)

mode4=2+((maxCandMode−1)%64)

mode5=2+((maxCandMode+61)%64)
If neither of candModeList[0] and candModeList[1] is equal to INTRA_PLANAR, candModeList[i], for i=2, 3, 4 and 5 are set equal to INTRA_PLANAR, mode3, mode4 and mode5, respectively,
Otherwise, if neither of candModeList[0] and candModeList[1] is equal to INTRA_DC, candModeList[i], for i=2, 3, 4 and 5 are set equal to INTRA_DC, mode3, mode4 and mode5, respectively,
Otherwise, candModeList[i], for i=2, 3, 4 and 5 are set equal to INTRA_ANGULAR50, INTRA_ANGULAR18, INTRA_ANGULAR2 and INTRA_ANGULAR34, respectively.
4. IntraPredModeY[xCb][yCb] is derived by applying the following procedure:
   If intra_luma_mpm_flag[xCb][yCb] is equal to 1, the IntraPredModeY[xCb][yCb] is set equal to candModeList[intra_luma_mpm_idx[xCb][yCb] ].
   Otherwise, IntraPredModeY[xCb][yCb] is derived by applying the following ordered steps:
   5. The array candModeList[x], x=0 . . . 2 is modified by the following ordered steps:
      i. When candModeList[0] is greater than candModeList[1], both values are swapped as follows:

(candModeList[0],candModeList[1])=Swap(candModeList[0],candModeList[1]) (8-9)
ii. When candModeList[0] is greater than candModeList[2], both values are swapped as follows:

(candModeList[0],candModeList[2])=Swap(candModeList[0],candModeList[2]) (8-10)
iii. When candModeList[1] is greater than candModeList[2], both values are swapped as follows:

(candModeList[1],candModeList[2])=Swap(candModeList[1],candModeList[2]) (8-11)
6. IntraPredModeY[xCb][yCb] is derived by the following ordered steps:
   i. IntraPredModeY[xCb][yCb] is set equal to intra_luma_mpm_remainder[xCb][yCb].
   ii. For i equal to 0 to 2, inclusive, when IntraPredModeY[xCb] [yCb] is greater than or equal to candModeList[i], the value of IntraPredModeY[xCb][yCb] is incremented by one.

The variable IntraPredModeY[x][y] with x=xCb . . . xCb+cbWidth−1 and y=yCb . . . yCb+cbHeight−1 is set to be equal to IntraPredModeY[xCb][yCb].

In some embodiments, the value of 2+((candIntraPredModeA+61) % 64) and 2+((maxCandMode+61) % 64) are replaced by VER_IDX.

In other embodiments, other neighbouring blocks may be used to derive the MPM members; e.g. below-left and above-right blocks instead of left and above blocks, respectively. In another example, different samples are used to determine the left and above blocks, e.g. using blocks in a different position than used by the current MPM process.

In another example embodiment illustrated below, modifications may be made to those made above, but changes are made to the conditions used in determining the MPM candidates.

8.2.2 Derivation Process for Luma Intra Prediction Mode

Input to this process are:
a luma location (xCb, yCb) specifying the top-left sample of the current luma coding block relative to the top-left luma sample of the current picture,
a variable cbWidth specifying the width of the current coding block in luma samples,
a variable cbHeight specifying the height of the current coding block in luma samples.

In this process, the luma intra prediction mode IntraPredModeY[xCb][yCb] is derived.
Table 8-1 specifies the value for the intra prediction mode IntraPredModeY[xCb][yCb] and the associated names.

TABLE 8-1
Specification of intra prediction mode and associated names

| Intra prediction | |
|---|---|
| mode | Associated name |
| 0 | INTRA_PLANAR |
| 1 | INTRA_DC |
| 2 . . . 66 | INTRA_ANGULAR2 . . . INTRA_ANGULAR66 |
| 77 | INTRA_CCLM |

NOTE -:
The intra prediction mode INTRA_CCLM is only applicable to chroma components.

IntraPredModeY[xCb][yCb] is derived by the following ordered steps:
1. The neighbouring locations (xNbA, yNbA) and (xNbB, yNbB) are set equal to (xCb−1, yCb) and (xCb, yCb−1), respectively.
2. For X being replaced by either A or B, the variables candIntraPredModeX are derived as follows:
   The availability derivation process for a block as specified in clause 6.4.X [Ed. (BB): Neighbouring blocks availability checking process tbd] is invoked with the location (xCurr, yCurr) set equal to (xCb, yCb) and the neighbouring location (xNbY, yNbY) set equal to (xNbX, yNbX) as inputs, and the output is assigned to availableX.
   The candidate intra prediction mode candIntraPredModeX is derived as follows:
      If one or more of the following conditions are true, candIntraPredModeX is set equal to INTRA_DC.
         The variable availableX is equal to FALSE.
         CuPredMode[xNbX][yNbX] is not equal to MODE_INTRA.
         X is equal to B and yCb−1 is less than ((yCb>>CtbLog2SizeY)<<CtbLog2SizeY).
      Otherwise, candIntraPredModeX is set equal to IntraPredModeY[xNbX][yNbX].
3. The candModeList[x] with x=0 . . . 5 is derived as follows:
   If candIntraPredModeB is equal to candIntraPredModeA, the following applies:
      If candIntraPredModeA is less than 2 (i.e., equal to INTRA_PLANAR or INTRA_DC), candModeList[x] with x=0 . . . 2 is derived as follows:

candModeList[0]=INTRA_PLANAR (8-1)

candModeList[1]=INTRA_DC (8-2)

candModeList[2]=INTRA_ANGULAR50 (8-3)

candModeList[3]=INTRA_ANGULAR18 (8-x)

candModeList[4]=INTRA_ANGULAR2 (8-x)

candModeList[5]=INTRA_ANGULAR34 (8-x)
Otherwise, candModeList[x] with x=0 . . . 2 is derived as follows:

candModeList[0]=candIntraPredModeA (8-4)

candModeList[1]=2+((candIntraPredModeA+62)%64) (8-5)

candModeList[2]=2+((candIntraPredModeA−1)%64) (8-6)

candModeList[3]=INTRA_PLANAR (8-x)

candModeList[4]=INTRA_DC (8-x)

candModeList[5]=2+((candIntraPredModeA+61)%64) (8-x)
Otherwise (candIntraPredModeB is not equal to candIntraPredModeA), the following applies:
   candModeList[0] and candModeList[1] are derived as follows:

candModeList[0]=candIntraPredModeA (8-7)

candModeList[1]=candIntraPredModeB (8-8)

maxCandMode=max(candIntraPredModeA,candIntraPredModeB)

mode3=2+((maxCandMode+62)%64)

mode4=2+((maxCandMode−1)%64)

mode5=2+((maxCandMode+61)%64)
If neither of candModeList[0] and candModeList[1] is less than or equal to DC_IDX, candModeList[i], for i=2, 3, 4 and 5 are set equal to INTRA_PLANAR, DC_IDX, mode3, and mode4, respectively,
Otherwise, if neither of candModeList[0] and candModeList[1] is equal to INTRA_DC, candModeList[i], for i=2, 3, 4 and 5 are set equal to VER_IDX, HOR_IDX, INTRA_ANGULAR2 and INTRA_ANGULAR34, respectively,
Otherwise, candModeList[i], for i=2, 3, 4 and 5 are set equal to (! ((candIntraPredModeA>0) && (candIntraPredModeB>0)), mode3, mode4 and mode5, respectively.
4. IntraPredModeY[xCb][yCb] is derived by applying the following procedure:
   If intra_luma_mpm_flag[xCb][yCb] is equal to 1, the IntraPredModeY[xCb][yCb] is set equal to candModeList[intra_luma_mpm_idx[xCb][yCb] ].
   Otherwise, IntraPredModeY[xCb][yCb] is derived by applying the following ordered steps:
   7. The array candModeList[x], x=0 . . . 2 is modified by the following ordered steps:
      i. When candModeList[0] is greater than candModeList[1], both values are swapped as follows:

(candModeList[0],candModeList[1])=Swap(candModeList[0],candModeList[1]) (8-9)
ii. When candModeList[0] is greater than candModeList[2], both values are swapped as follows:

(candModeList[0],candModeList[2])=Swap(candModeList[0],candModeList[2]) (8-10)
iii. When candModeList[1] is greater than candModeList[2], both values are swapped as follows:

(candModeList[1],candModeList[2])=Swap(candModeList[1],candModeList[2]) (8-11)
8. IntraPredModeY[xCb][yCb] is derived by the following ordered steps:
   i. IntraPredModeY[xCb][yCb] is set equal to intra_luma_mpm_remainder[xCb][yCb].
   ii. For i equal to 0 to 2, inclusive, when IntraPredModeY[xCb] [yCb] is greater than or equal to candModeList[i], the value of IntraPredModeY[xCb][yCb] is incremented by one.
      The variable IntraPredModeY[x][y] with x=xCb . . . xCb+cbWidth−1 and y=yCb . . . yCb+cbHeight−1 is set to be equal to IntraPredModeY[xCb][yCb].

In another example embodiment illustrated below, other modifications may be made. The changes in this embodiment are shown with respect to the changes JVET-L1001-v4. The additions are highlighted by underline and the deletions are struck-through.

8.2.2 Derivation Process for Luma Intra Prediction Mode

Input to this process are:
a luma location (xCb, yCb) specifying the top-left sample of the current luma coding block relative to the top-left luma sample of the current picture,
a variable cbWidth specifying the width of the current coding block in luma samples,
a variable cbHeight specifying the height of the current coding block in luma samples.

In this process, the luma intra prediction mode IntraPredModeY[xCb][yCb] is derived.

Table 8-1 specifies the value for the intra prediction mode

IntraPredModeY[xCb][yCb] and the associated names.

TABLE 8-1
Specification of intra prediction mode and associated names

| Intra prediction | |
|---|---|
| mode | Associated name |
| 0 | INTRA_PLANAR |
| 1 | INTRA_DC |
| 2 . . . 66 | INTRA_ANGULAR2 . . . INTRA_ANGULAR66 |
| 81 . . . 83 | INTRA_LT_CCLM, INTRA_L_CCLM, |
| | INTRA_T_CCLM |

NOTE -:
The intra prediction modes INTRA_LT_CCLM, INTRA_L_CCLM and INTRA_T_CCLM are only applicable to chroma components.

IntraPredModeY[xCb][yCb] is derived by the following ordered steps:
9. The neighbouring locations (xNbA, yNbA) and (xNbB, yNbB) are set equal to (xCb−1, yCb+cbHeight−1) and (xCb+cbWidth−1, yCb−1), respectively.
10. For X being replaced by either A or B, the variables candIntraPredModeX are derived as follows:
   The availability derivation process for a block as specified in clause 6.4.X [Ed. (BB): Neighbouring blocks availability checking process tbd] is invoked with the location (xCurr, yCurr) set equal to (xCb, yCb) and the neighbouring location (xNbY, yNbY) set equal to (xNbX, yNbX) as inputs, and the output is assigned to availableX.
   The candidate intra prediction mode candIntraPredModeX is derived as follows:
      If one or more of the following conditions are true, candIntraPredModeX is set equal to INTRA_PLANAR.
         The variable availableX is equal to FALSE.
         CuPredMode[xNbX][yNbX] is not equal to MODE_INTRA.
         pcm_flag[xNbX][yNbX] is equal to 1.
         X is equal to B and yCb−1 is less than ((yCb>>CtbLog2SizeY)<<CtbLog2SizeY).
      Otherwise, candIntraPredModeX is set equal to IntraPredModeY[xNbX][yNbX].
11. The candModeList[x] with x=0 . . . 5 is derived as follows:
   If candIntraPredModeB is equal to candIntraPredModeA and candIntraPredModeA is greater than INTRA_DC, candModeList[x] with x=0 . . . 5 is derived as follows:
      If IntraLumaRefLineIdx[xCb][yCb] is equal to 0, the following applies:

candModeList[0]=candIntraPredModeA (8-4)

candModeList[1]=INTRA_PLANAR (8-5)

candModeList[2]=INTRA_DC (8-6)

candModeList[3]=2+((candIntraPredModeA+61)%64) (8-7)

candModeList[4]=2+(((candIntraPredModeA−1)%64) (8-8)

candModeList[5]=2+(((candIntraPredModeA+60)%64) (8-9)
Otherwise (IntraLumaRefLineIdx[xCb][yCb] is not equal to 0), the following applies:

candModeList[0]=candIntraPredModeA (8-10)

candModeList[1]=2+((candIntraPredModeA+61)%64) (8-11)

candModeList[2]=2+((candIntraPredModeA−1)%64) (8-12)

candModeList[3]=2+((candIntraPredModeA+60)%64) (8-13)

candModeList[4]=2+(candIntraPredModeA %64) (8-14)

candModeList[5]=2+(((candIntraPredModeA+59)%64) (8-15)
Otherwise if candIntraPredModeB is not equal to candIntraPredModeA and candIntraPredModeA or candIntraPredModeB is greater than INTRA_DC, the following applies:
   The variables minAB and maxAB are derived as follows:

minAB=Min(candIntraPredModeA,candIntraPredModeB) (8-16)

maxAB=Max(candIntraPredModeA,candIntraPredModeB) (8-17)
If candIntraPredModeA and candIntraPredModeB are both greater than INTRA_DC, candModeList[x] with x=0 . . . 5 is derived as follows:

candModeList[0]=candIntraPredModeA (8-18)

candModeList[1]=candIntraPredModeB (8-19)
If IntraLumaRefLineIdx[xCb][yCb] is equal to 0, the following applies:

candModeList[2]=INTRA_PLANAR (8-20)

candModeList[3]=INTRA_DC (8-21)
If maxAB-minAB is in the range of 2 to 62, inclusive, the following applies:

candModeList[4]=2+((maxAB+61)%64) (8-22)

candModeList[5]=2+((maxAB−1)%64) (8-23)
Otherwise, the following applies:

candModeList[4]=2+((maxAB+60)%64) (8-24)

candModeList[5]=2+((maxAB)%64) (8-25)
Otherwise (IntraLumaRefLineIdx[xCb][yCb] is not equal to 0), the following applies:
If maxAB-minAB is equal to 1, the following applies:

candModeList[2]=2+((minAB+61)%64) (8-26)

candModeList[3]=2+((maxAB−1)%64) (8-27)

candModeList[4]=2+((minAB+60)%64) (8-28)

candModeList[5]=2+(maxAB %64) (8-29)
Otherwise if maxAB-minAB is equal to 2, the following applies:

candModeList[2]=2+((minAB−1)%64) (8-30)

candModeList[3]=2+((minAB+61)%64) (8-31)

candModeList[4]=2+((maxAB−1)%64) (8-32)

candModeList[5]=2+((minAB+60)%64) (8-33)
Otherwise if maxAB-minAB is greater than 61, the following applies:

candModeList[2]=2+((minAB−1)%64) (8-34)

candModeList[3]=2+((maxAB+61)%64) (8-35)

candModeList[4]=2+(minAB %64) (8-36)

candModeList[5]=2+((maxAB+60)%64) (8-37)
Otherwise, the following applies:

candModeList[2]=2+((minAB+61)%64) (8-38)

candModeList[3]=2+((minAB−1)%64) (8-39)

candModeList[4]=2+((maxAB+61)%64) (8-40)

candModeList[5]=2+((maxAB−1)%64) (8-41)
Otherwise (candIntraPredModeA or candIntraPredModeB is greater than INTRA_DC), candModeList[x] with x=0 . . . 5 is derived as follows:
   If IntraLumaRefLineIdx[xCb][yCb] is equal to 0, the following applies:

candModeList[0]=candIntraPredModeA (8-42)

candModeList[1]=candIntraPredModeB (8-43)

candModeList[2]=1−minAB (8-44)

candModeList[3]=2+((maxAB+61)%64) (8-45)

candModeList[4]=2+((maxAB−1)%64) (8-46)

candModeList[5]=2+((maxAB+60)%64) (8-47)
Otherwise (IntraLumaRefLineIdx[xCb][yCb] is not equal to 0), the following applies:

candModeList[0]=maxAB (8-48)

candModeList[1]=2+((maxAB+61)%64) (8-49)

candModeList[2]=2+((maxAB−1)%64) (8-50)

candModeList[3]=2+((maxAB+60)%64) (8-51)

candModeList[4]=2+(maxAB%64) (8-52)

candModeList[5]=2+((maxAB+59)%64) (8-53)
Otherwise, the following applies:
   If IntraLumaRefLineIdx[xCb] [yCb] is equal to 0, the following applies:

candModeList[0]=candIntraPredModeA (8-54)

candModeList[1]=(candModeList[0]==INTRA_PLANAR)?INTRA_DC: (8-55)
INTRA_PLANAR

candModeList[2]=INTRA_ANGULAR50 (8-56)

candModeList[3]=INTRA_ANGULAR18 (8-57)

candModeList[4]=INTRA_ANGULAR46 (8-58)

candModeList[5]=INTRA_ANGULAR54 (8-59)
Otherwise (IntraLumaRefLineIdx[xCb][yCb] is not equal to 0), the following applies:

candModeList[0]=INTRA_ANGULAR50 (8-60)

candModeList[1]=INTRA_ANGULAR18 (8-61)

candModeList[2]=INTRA_ANGULAR2 (8-62)

candModeList[3]=INTRA_ANGULAR34 (8-63)

candModeList[4]=INTRA_ANGULAR66 (8-64)

candModeList[5]=INTRA_ANGULAR26 (8-65)
4. IntraPredModeY[xCb][yCb] is derived by applying the following procedure:
   If intra_luma_mpm_flag[xCb][yCb] is equal to 1, the IntraPredModeY[xCb][yCb] is set equal to candModeList[intra_luma_mpm_idx[xCb][yCb] ].
   Otherwise, IntraPredModeY[xCb][yCb] is derived by applying the following ordered steps:
      1. IntraPredModeY[xCb][yCb] is derived as follows:

maxModeVal=Max(candModeList[0],Max(candModeList[1],candModeList[2])−2

IntraPredModeY[xCb][yCb]=intra_luma_mpm_remainder+2+(intra_luma_mpm_remainder>=maxModeVal−2)?1:0

The variable IntraPredModeY[x][y] with x=xCb . . . xCb+cbWidth−1 and y=yCb . . . yCb+cbHeight−1 is set to be equal to IntraPredModeY[xCb][yCb].

In one alternative, the IntraPredModeY[ ][ ] is derived as follows:
4. IntraPredModeY[xCb][yCb] is derived by applying the following procedure:
   If intra_luma_mpm_flag[xCb][yCb] is equal to 1, the IntraPredModeY[xCb][yCb] is set equal to candModeList[intra_luma_mpm_idx[xCb][yCb] ].
   Otherwise, IntraPredModeY[xCb][yCb] is derived as follows:
      2. maxModeVal=Max(candModeList[0], Max(candModeList[1], candModeList[2]) IntraPredModeY[xCb][yCb]=(intra_luma_mpm_remainder>=maxModeVal−2)?intra_luma_mpm_remainder+3: intra_luma_mpm_remainder+2

In another example embodiment illustrated below, further modifications may be made. The changes in this embodiment are shown with respect to the changes JVET-L1001-v4. The additions are highlighted by underline, and the deletions are struck-through.

8.2.2 Derivation Process for Luma Intra Prediction Mode

Input to this process are:
a luma location (xCb, yCb) specifying the top-left sample of the current luma coding block relative to the top-left luma sample of the current picture,
a variable cbWidth specifying the width of the current coding block in luma samples,
a variable cbHeight specifying the height of the current coding block in luma samples.

In this process, the luma intra prediction mode IntraPredModeY[xCb][yCb] is derived.

Table 8-1 specifies the value for the intra prediction mode

IntraPredModeY[xCb][yCb] and the associated names.

TABLE 8-1
Specification of intra prediction mode and associated names

| Intra prediction | |
|---|---|
| mode | Associated name |
| 0 | INTRA_PLANAR |
| 1 | INTRA_DC |
| 2 . . . 66 | INTRA_ANGULAR2 . . . INTRA_ANGULAR66 |
| 81 . . . 83 | INTRA_LT_CCLM, INTRA_L_CCLM, |
| | INTRA_T_CCLM |

NOTE -:
The intra prediction modes INTRA_LT_CCLM, INTRA_L_CCLM and INTRA_T_CCLM are only applicable to chroma components.

IntraPredModeY[xCb][yCb] is derived by the following ordered steps:
1. The neighbouring locations (xNbA, yNbA) and (xNbB, yNbB) are set equal to (xCb−1, yCb+cbHeight−1) and (xCb+cbWidth−1, yCb−1), respectively.
2. For X being replaced by either A or B, the variables candIntraPredModeX are derived as follows:
   The availability derivation process for a block as specified in clause 6.4.X [Ed. (BB): Neighbouring blocks availability checking process tbd] is invoked with the location (xCurr, yCurr) set equal to (xCb, yCb) and the neighbouring location (xNbY, yNbY) set equal to (xNbX, yNbX) as inputs, and the output is assigned to availableX.
   The candidate intra prediction mode candIntraPredModeX is derived as follows:
      If one or more of the following conditions are true, candIntraPredModeX is set equal to INTRA_PLANAR.
         The variable availableX is equal to FALSE.
         CuPredMode[xNbX][yNbX] is not equal to MODE_INTRA.
         pcm_flag[xNbX][yNbX] is equal to 1.
         X is equal to B and yCb−1 is less than ((yCb>>CtbLog2SizeY)<<CtbLog2SizeY).
      Otherwise, candIntraPredModeX is set equal to IntraPredModeY[xNbX][yNbX].
3. The candModeList[x] with x=0 . . . 5 is derived as follows:
   If candIntraPredModeB is equal to candIntraPredModeA and candIntraPredModeA is greater than INTRA_DC, candModeList[x] with x=0 . . . 5 is derived as follows:
      If IntraLumaRefLineIdx[xCb][yCb] is equal to 0, the following applies:

candModeList[0]=candIntraPredModeA (8-4)

candModeList[1]=INTRA_PLANAR (8-5)

candModeList[2]=INTRA_DC (8-6)

candModeList[3]=2+((candIntraPredModeA+61)%64) (8-7)

candModeList[4]=2+(((candIntraPredModeA−1)%64) (8-8)

candModeList[5]=2+(((candIntraPredModeA+60)%64) (8-9)

maxModeVal=candIntraPredModeA
Otherwise (IntraLumaRefLineIdx[xCb][yCb] is not equal to 0), the following applies:

candModeList[0]=candIntraPredModeA (8-10)

candModeList[1]=2+((candIntraPredModeA+61)%64) (8-11)

candModeList[2]=2+((candIntraPredModeA−1)%64) (8-12)

candModeList[3]=2+((candIntraPredModeA+60)%64) (8-13)

candModeList[4]=2+(candIntraPredModeA%64) (8-14)

candModeList[5]=2+(((candIntraPredModeA+59)%64) (8-15)
Otherwise if candIntraPredModeB is not equal to candIntraPredModeA and candIntraPredModeA or candIntraPredModeB is greater than INTRA_DC, the following applies:
   The variables minAB and maxAB are derived as follows:

minAB=Min(candIntraPredModeA,candIntraPredModeB) (8-16)

maxAB=Max(candIntraPredModeA,candIntraPredModeB) (8-17)

maxModeVal=maxAB
If candIntraPredModeA and candIntraPredModeB are both greater than INTRA_DC, candModeList[x] with x=0 . . . 5 is derived as follows:

candModeList[0]=candIntraPredModeA (8-18)

candModeList[1]=candIntraPredModeB (8-19)
If IntraLumaRefLineIdx[xCb][yCb] is equal to 0, the following applies:

candModeList[2]=INTRA_PLANAR (8-20)

candModeList[3]=INTRA_DC (8-21)
If maxAB-minAB is in the range of 2 to 62, inclusive, the following applies:

candModeList[4]=2+((maxAB+61)%64) (8-22)

candModeList[5]=2+((maxAB−1)%64) (8-23)
Otherwise, the following applies:

candModeList[4]=2+((maxAB+60)%64) (8-24)

candModeList[5]=2+((maxAB)%64) (8-25)
Otherwise (IntraLumaRefLineIdx[xCb][yCb] is not equal to 0), the following applies:
If maxAB-minAB is equal to 1, the following applies:

candModeList[2]=2+((minAB+61)%64) (8-26)

candModeList[3]=2+((maxAB−1)%64) (8-27)

candModeList[4]=2+((minAB+60)%64) (8-28)

candModeList[5]=2+(maxAB%64) (8-29)
Otherwise if maxAB-minAB is equal to 2, the following applies:

candModeList[2]=2+((minAB−1)%64) (8-30)

candModeList[3]=2+((minAB+61)%64) (8-31)

candModeList[4]=2+((maxAB−1)%64) (8-32)

candModeList[5]=2+((minAB+60)%64) (8-33)
Otherwise if maxAB-minAB is greater than 61, the following applies:

candModeList[2]=2+((minAB−1)%64) (8-34)

candModeList[3]=2+((maxAB+61)%64) (8-35)

candModeList[4]=2+(minAB%64) (8-36)

candModeList[5]=2+((maxAB+60)%64) (8-37)
Otherwise, the following applies:

candModeList[2]=2+((minAB+61)%64) (8-38)

candModeList[3]=2+((minAB−1)%64) (8-39)

candModeList[4]=2+((maxAB+61)%64) (8-40)

candModeList[5]=2+((maxAB−1)%64) (8-41)
Otherwise (candIntraPredModeA or candIntraPredModeB is greater than INTRA_DC), candModeList[x] with x=0 . . . 5 is derived as follows:
   If IntraLumaRefLineIdx[xCb][yCb] is equal to 0, the following applies:

candModeList[0]=candIntraPredModeA (8-42)

candModeList[1]=candIntraPredModeB (8-43)

candModeList[2]=1−minAB (8-44)

candModeList[3]=2+((maxAB+61)%64) (8-45)

candModeList[4]=2+((maxAB−1)%64) (8-46)

candModeList[5]=2+((maxAB+60)%64) (8-47)
Otherwise (IntraLumaRefLineIdx[xCb][yCb] is not equal to 0), the following applies:

candModeList[0]=maxAB (8-48)

candModeList[1]=2+((maxAB+61)%64) (8-49)

candModeList[2]=2+((maxAB−1)%64) (8-50)

candModeList[3]=2+((maxAB+60)%64) (8-51)

candModeList[4]=2+(maxAB%64) (8-52)

candModeList[5]=2+((maxAB+59)%64) (8-53)
Otherwise, the following applies:
   If IntraLumaRefLineIdx[xCb] [yCb] is equal to 0, the following applies:

candModeList[0]=candIntraPredModeA (8-54)

candModeList[1]=(candModeList[0]==INTRA_PLANAR)?INTRA_DC: (8-55)
INTRA_PLANAR

candModeList[2]=INTRA_ANGULAR50 (8-56)

candModeList[3]=INTRA_ANGULAR18 (8-57)

candModeList[4]=INTRA_ANGULAR46 (8-58)

candModeList[5]=INTRA_ANGULAR54 (8-59)

maxModeVal=INTRA_ANGULAR50
Otherwise (IntraLumaRefLineIdx[xCb][yCb] is not equal to 0), the following applies:

candModeList[0]=INTRA_ANGULAR50 (8-60)

candModeList[1]=INTRA_ANGULAR18 (8-61)

candModeList[2]=INTRA_ANGULAR2 (8-62)

candModeList[3]=INTRA_ANGULAR34 (8-63)

candModeList[4]=INTRA_ANGULAR66 (8-64)

candModeList[5]=INTRA_ANGULAR26 (8-65)
4. IntraPredModeY[xCb][yCb] is derived by applying the following procedure:
   If intra_luma_mpm_flag[xCb][yCb] is equal to 1, the IntraPredModeY[xCb][yCb] is set equal to candModeList[intra_luma_mpm_idx[xCb][yCb] ].
   Otherwise, IntraPredModeY[xCb][yCb] is derived as follows:

IntraPredModeY[xCb][vCb]=intra_luma_mpm_remainder+2+(intra_luma_mpm_remainder>=maxModeVal)?1:0

The variable IntraPredModeY[x][y] with x=xCb . . . xCb+cbWidth−1 and y=yCb . . . yCb+cbHeight−1 is set to be equal to IntraPredModeY[xCb][yCb].

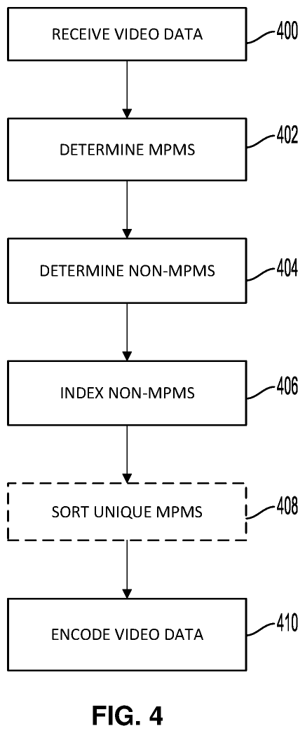

FIG. 4 illustrates a flowchart illustrating an example encoding method. For example, the method may execute on a video encoder as discussed above.

In block 400, the video encoder may receive a video data to be encoded. For example, the video data may be retrieved from a video data memory. The video data may include a plurality of blocks.

In block 402, the video encoder may determine a set of most probable modes (MPMs) for intra prediction of a current block to be coded. The set of MPMs may include intra prediction modes of previously coded neighboring blocks. The set of MPMs may further include one or more default intra prediction modes. The quantity of MPMs in the set of MPMs may be dependent on a current block size, a current block characteristic, and a current block neighborhood.

In block 404, the video encoder may determine a set of non-MPMs. The set of non-MPMs may include intra prediction modes not in the set of MPMs determined above.

In block 406, the video encoder may index the set of non-MPM modes based on unique modes within the set of MPMs.

In block 408, the video encoder may optionally sort the set of unique modes within the set of MPMs. The video encoder may further re-indexing the non-MPMs based on the sorted set of MPMs.

In block 410, the video encoder may encode the video data, the set of MPMs, and the set of non-MPMs into a bitstream to be stored or displayed. It will be appreciated that the quantity of MPMs in the set of MPMs may be entropy coded with context and signaled in the bitstream.

The set of MPMs may be encoded as a first index in the bitstream, and the set of non-MPMs are encoded as a second index in the bitstream. The bitstream may be encoded in accordance with the Versatile Video Coding standard.

It is to be recognized that depending on the example, certain acts or events of any of the techniques described herein can be performed in a different sequence, may be added, merged, or left out altogether (e.g., not all described acts or events are necessary for the practice of the techniques). Moreover, in certain examples, acts or events may be performed concurrently, e.g., through multi-threaded processing, interrupt processing, or multiple processors, rather than sequentially.

In one or more examples, the functions described may be implemented in hardware, software, firmware, or any combination thereof. If implemented in software, the functions may be stored on or transmitted over as one or more instructions or code on a computer-readable medium and executed by a hardware-based processing unit. Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable medium.

By way of example, and not limitation, such computer-readable storage media can comprise RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transitory media, but are instead directed to non-transitory, tangible storage media. Disk and disc, as used herein, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of computer-readable media.

Instructions may be executed by one or more processors, such as one or more digital signal processors (DSPs), general purpose microprocessors, application specific integrated circuits (ASICs), field programmable gate arrays (FPGAs), or other equivalent integrated or discrete logic circuitry. Accordingly, the term “processor,” as used herein may refer to any of the foregoing structure or any other structure suitable for implementation of the techniques described herein. In addition, in some aspects, the functionality described herein may be provided within dedicated hardware and/or software modules configured for encoding and decoding, or incorporated in a combined codec. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a codec hardware unit or provided by a collection of interoperative hardware units, including one or more processors as described above, in conjunction with suitable software and/or firmware.

Various examples have been described. These and other examples are within the scope of the following claims.

What is claimed is:

1. A method for decoding video data, comprising:
receiving a bitstream encoding video data to be stored or displayed, the video data include a plurality of blocks;
determining a set of most probable modes (MPMs) for intra prediction of a current block to be decoded, wherein the set of MPMs includes intra prediction modes of previously coded neighboring blocks;
determining a set of non-MPMs, wherein the set of non-MPMs include intra prediction modes not in the set of MPMs;
parsing a MPM index or a non-MPM index indicating a selected intra prediction mode for the current block from the bitstream; and
decoding the current block of the video data using the selected inter prediction.

2. The method of claim 1, wherein a subset of the MPMs are unique.

3. The method of claim 2, wherein the set of non-MPMs is further indexed based on the subset of unique MPMs.

4. The method of claim 2, wherein the subset of unique MPMs are sorted.

5. The method of claim 1, wherein the set of MPMs further includes one or more default intra prediction modes.

6. The method of claim 1, wherein the MPM index or non-MPM index is entropy decoded with context from the bitstream.

7. The method of claim 1, wherein a quantity of MPMs in the set of MPMs is dependent on at least one of: a current block size, a current block characteristic, and a current block neighborhood.

8. The method of claim 7, further comprising:
parsing the quantity of MPMs from the bitstream.

9. A method for encoding video data, comprising:
receiving a video data to be encoded, the video data include a plurality of blocks;
determining a set of most probable modes (MPMs) for intra prediction of a current block to be encoded, wherein the set of MPMs includes intra prediction modes of previously coded neighboring blocks;
determining a set of non-MPMs, wherein the set of non-MPMs include intra prediction modes not in the set of MPMs;
encoding a current block using a selected intra prediction mode;
encoding the video data and a MPM index or a non-MPM index indicating the selected intra prediction mode into a bitstream to be stored or displayed.

10. The method of claim 9, wherein a subset of the MPMs are unique.

11. The method of claim 10, wherein the set of non-MPMs is further indexed based on the subset of unique MPMs.

12. The method of claim 10, wherein the subset of unique MPMs are sorted.

13. The method of claim 9, wherein the set of MPMs further includes one or more default intra prediction modes.

14. The method of claim 9, wherein the MPM index or non-MPM index is entropy decoded with context from the bitstream.

15. The method of claim 9, wherein a quantity of MPMs in the set of MPMs is dependent on at least one of: a current block size, a current block characteristic, and a current block neighborhood.

16. The method of claim 15, further comprising:
signaling the quantity of MPMs in the set of MPMs from the bitstream.

17. An apparatus for decoding video data, comprising:
an input interface for receiving a bitstream encoding video data to be stored or displayed, the video data include a plurality of blocks; and
a processor, the processor configured to,
determine a set of most probable modes (MPMs) for intra prediction of a current block to be decoded, wherein the set of MPMs includes intra prediction modes of previously coded neighboring blocks,
determine a set of non-MPMs, wherein the set of non-MPMs include intra prediction modes not in the set of MPMs,
parse a MPM index or a non-MPM index indicating a selected intra prediction mode for the current block from the bitstream, and
decode the current block of the video data using the selected inter prediction.

18. The apparatus of claim 17, wherein a subset of the MPMs are unique.

19. The apparatus of claim 18, wherein the set of non-MPMs is further indexed based on the subset of unique MPMs.

20. The apparatus of claim 18, wherein the subset of unique MPMs are sorted.

21. The apparatus of claim 17, wherein the set of MPMs further includes one or more default intra prediction modes.

22. The apparatus of claim 17, wherein the MPM index or non-MPM index is entropy decoded with context from the bitstream.

23. The apparatus of claim 17, wherein a quantity of MPMs in the set of MPMs is dependent on at least one of: a current block size, a current block characteristic, and a current block neighborhood.

24. The apparatus of claim 23, the processor further configured to,
parse the quantity of MPMs from the bitstream.

25. An apparatus for encoding video data, comprising:
a receiver for receiving a video data from a video source to be encoded, the video data include a plurality of blocks; and
a processor, the processor configured to,
determine a set of most probable modes (MPMs) for intra prediction of a current block to be encoded, wherein the set of MPMs includes intra prediction modes of previously coded neighboring blocks,
determine a set of non-MPMs, wherein the set of non-MPMs include intra prediction modes not in the set of MPMs,
encode a current block using a selected intra prediction mode, and
encode the video data and a MPM index or a non-MPM index indicating the selected intra prediction mode into a bitstream to be stored or displayed.

26. The apparatus of claim 25, wherein a subset of the MPMs are unique.

27. The apparatus of claim 26, wherein the set of non-MPMs is further indexed based on the subset of unique MPMs.

28. The apparatus of claim 26, wherein the subset of unique MPMs are sorted.

29. The apparatus of claim 25, wherein the set of MPMs further includes one or more default intra prediction modes and the MPM index or non-MPM index is entropy decoded with context from the bitstream.

30. The apparatus of claim 25, wherein a quantity of MPMs in the set of MPMs is dependent on at least one of: a current block size, a current block characteristic, and a current block neighborhood, and the processor is further configured to signal the quantity of MPMs in the set of MPMs from the bitstream.
